(19) United States
(12) Patent Application Publication
(10) Pub. No.: US 2014/0069794 A1
(43) Pub. Date: Mar. 13, 2014

(54) Systems and Methods for Providing Inputs to an Electronic Device with a Button Assmebly

(71) Applicant: APPLE INC., Cupertino, CA (US)

(72) Inventors: Wey-Jiun Lin, Los Altos, CA (US); Jiping Wu, Shenzhen (CN)

(73) Assignee: Apple Inc., Cupertino, CA (US)

(21) Appl. No.: 13/833,993

(22) Filed: Mar. 15, 2013

Related U.S. Application Data
(60) Provisional application No. 61/699,809, filed on Sep. 11, 2012.
(60) Provisional application No. 61/699,845, filed on Sep. 11, 2012.

(51) Int. Cl. H01H 23/02; H01H 11/00

(52) U.S. Cl. CPC H01H 23/02; H01H 11/00
USPC 200/529; 29/622

(57) ABSTRACT

This is directed to systems and methods for providing inputs to an electronic device with a button assembly. In some embodiments, a button assembly may include a button having distinguishable regions, limbs, and a set of switches positioned adjacent the button, where at least one of the switches is activated when one of the regions is actuated. In some embodiments, a button assembly may span a support member of a housing, and may be at least partially secured in an opening of the housing by bracket. In these embodiments, the button assembly may be operative to rotate about an axis in response to a user interaction event to activate a switch.

### FIELD OF THE INVENTION

This relates to systems and methods for providing inputs to an electronic device and, more particularly, to systems and methods for providing inputs to an electronic device with a button assembly.

### BACKGROUND OF THE INVENTION

Many electronic devices include mechanisms for entering inputs. For example, an electronic device typically includes one or more buttons, such as a power button, one or more volume control buttons, and various other buttons for entering inputs to the electronic device. However, each of these buttons may add to a total part count of the electronic device. Moreover, each button may be different in at least one of size, shape, material, and manufacturing requirements, which may increase manufacturing time and costs of the electronic device.

### SUMMARY OF THE INVENTION

Systems and methods for providing inputs to an electronic device with a button assembly are provided.

In at least one embodiment, a button assembly is provided. The button assembly can include a button having a center region, a first end region extending from a first side of the center region, and a second end region extending from a second side of the center region that is opposite the first side. The button assembly can also include a first limb coupled to the button proximate the first side of the center region, a second limb coupled to the button proximate the second side of the center region, and a set of switches positioned adjacent the button. At least one of the switches can be actuatable when one of the center region, the first end region, and the second region is depressed.

In at least one embodiment, an electronic device is provided. The electronic device can include a housing, a set of switches disposed within the housing, and

a button secured to the housing and having a set of regions. Each region of the set of regions can be positioned adjacent to a respective switch of the set of switches. The button can be configured to displace with respect to the housing in a first manner when an external force is applied to a first region of the set of regions, and displace with respect to the housing in a second manner when the external force is applied to a second region of the set of regions.

In at least one embodiment, a method of integrating a button assembly with an electronic device is provided. The button assembly can include a set of switches and a button having a first end region, a second end region, and a center region disposed between the first end region and the second end region. The electronic device can include a housing having an aperture. The method can include positioning the set of switches within the housing adjacent to the aperture, aligning each of the first end region, the second end region, and the center region with a respective switch of the set of switches, and securing the button to the housing.

In at least one embodiment, a button assembly is provided. The button assembly can include a rocker button having a pivot region and first and second arms that extend away from the pivot region in opposite directions, and a bracket including first and second switches mounted thereon. The bracket can be securable to a support member of a housing and at least one other location on the housing to retain the rocker button within an opening of the housing. The rocker button can be configured to pivot on the pivot region to engage one of the first and second switches, in response to a switch activation event.

In at least one embodiment, an electronic device is provided. The electronic device can include a housing having an opening and a support member that spans the opening, and a bracket coupled to the support member. The bracket can include first and second regions that extend from one another in substantially orthogonal directions. The electronic device can also include a rocker button assembly that spans the support member. The button assembly can be at least partially secured in the opening by the bracket.

In at least one embodiment, a button assembly can include a housing having an opening and a set of retention features positioned within the opening, and a button positioned within the opening. The button can be partially retained by the set of retention features. The button assembly can also include a bracket having a first planar region and a second planar region. The first planar region can interface with a first portion of the button assembly along a first plane. The second planar region can interface with a second portion of the button assembly along a second plane that is substantially perpendicular to the first region.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters refer to like parts throughout, and in which:

FIG. 1 shows a schematic view of an illustrative electronic device, in accordance with at least one embodiment;

FIG. 2A shows a front view of the electronic device of FIG. 1, the electronic device including a button assembly, in accordance with at least one embodiment;

FIG. 2B shows a side view of the electronic device of FIGS. 1 and 2A, taken from line IIB-IIB of FIG. 2A, in accordance with at least one embodiment;

FIG. 3A shows a top view of the button assembly of FIGS. 2A and 2B, in accordance with at least one embodiment;

FIG. 3B shows a side view of the button assembly of FIGS. 2A-3A, taken from line IIIB-IIIB of FIG. 3A, in accordance with at least one embodiment;

FIG. 4A shows side view, similar to FIG. 3B, of the button assembly of FIGS. 2A-3B and a set of switches, in accordance with at least one embodiment;

FIG. 4B shows a side view, similar to FIG. 4A, of a simplified representation of the button assembly of FIGS. 2A-4A and the set of switches of FIG. 4A, the combination of the button assembly and the set of switches being in a first configuration, in accordance with at least one embodiment;

FIG. 4C shows a side view, similar to FIG. 4A, of a simplified representation of the button assembly of FIGS. 2A-4B and the set of switches of FIGS. 4A and 4B, the combination of the button assembly and the set of switches being in a second configuration, in accordance with at least one embodiment;

FIG. 4D shows a side view, similar to FIG. 4B, of a simplified representation of the button assembly of FIGS. 2A-4A and the set of switches of FIGS. 4A-4C, the combination of the button assembly and the set of switches being in a third configuration, in accordance with at least one embodiment;

FIG. 5 shows a perspective view of a portion of the electronic device of FIGS. 1-2B, the portion including the button assembly of FIGS. 2A-4A and the set of switches of FIGS. 4A-4C, in accordance with at least one embodiment;

FIG. 6 shows a side view, similar to FIG. 3B, of the portion of the electronic device of FIG. 5, in accordance with at least one embodiment;

FIG. 7 shows a top view, similar to FIG. 3A, of the button assembly of FIGS. 2A-4A, 5, and 6, the button assembly including markings, in accordance with at least one embodiment;

FIG. 8 shows a side view, similar to FIG. 3B, of a first alternative button assembly, similar to the button assembly of FIGS. 2A-4A and 5-7, in accordance with at least one embodiment;

FIG. 9 shows a perspective view, similar to FIG. 5, of the portion of the electronic device of FIG. 5, the portion including the first alternative button assembly of FIG. 8 and the set of switches of FIGS. 4A-6, in accordance with at least one embodiment;

FIG. 10 shows a side view, similar to FIG. 8, of a second alternative button assembly, similar to the button assembly of FIGS. 2A-4A and 5-7 and the first alternative button assembly of FIGS. 8 and 9, in accordance with at least one embodiment;

FIG. 11 shows a perspective view, similar to FIG. 9, of the portion of the electronic device of FIGS. 5 and 9, the portion including the second alternative button assembly of FIG. 10 and the set of switches of FIGS. 4A-6 and 9, in accordance with at least one embodiment;

FIG. 12 shows a partial cross-sectional view of the portion of the electronic device of FIG. 11, taken from line XII-XII of FIG. 11, in accordance with at least one embodiment;

FIG. 13 shows a partial cross-sectional view, similar to FIG. 12, of the portion of the electronic device of FIG. 11, taken from line XIII-XIII of FIG. 11, in accordance with at least one embodiment;

FIG. 14 shows a partial cross-sectional view, similar to FIGS. 12 and 13, of the portion of the electronic device of FIG. 11, taken from line XIV-XIV of FIG. 11, in accordance with at least one embodiment;

FIG. 15A shows a view of the button assembly of FIGS. 10-14 and the set of switches of FIGS. 4A-6 and 9, taken from line XVA-XVA of FIG. 10, in accordance with at least one embodiment;

FIG. 15B shows a view of the button assembly of FIGS. 2A-4A and 5-7 and the set of switches of FIGS. 4A-6 and 9, taken from line XVB-XVB of FIG. 4A, in accordance with at least one embodiment;

FIG. 15C shows a view of the button assembly of FIGS. 8 and 9 and the set of switches of FIGS. 4A-6 and 9, taken from line XVC-XVC of FIG. 8, in accordance with at least one embodiment;

FIG. 16 is a flowchart of an illustrative process for integrating a button assembly with an electronic device, in accordance with at least one embodiment;

FIG. 17A shows a perspective view of a portion of another illustrative electronic device, including a button assembly, in accordance with at least one embodiment;

FIG. 17B shows a similar view of the electronic device of FIG. 17A, including an exploded view of the button assembly of FIG. 17A, in accordance with at least one embodiment;

FIG. 18A shows a perspective view of yet another illustrative electronic device, including an exploded view of another button assembly, in accordance with at least one embodiment;

FIG. 18B shows a view from the inside of the electronic device of FIG. 18A, in accordance with at least one embodiment;

FIG. 19A shows a cross-sectional view of yet still another illustrative electronic device, including another button assembly, in accordance with at least one embodiment;

FIG. 19B shows a cross-sectional view of the electronic device of FIG. 19A, with the button assembly of FIG. 19A fully assembled, in accordance with at least one embodiment;

FIG. 19C shows a view from the inside of the electronic device of FIG. 19A, in accordance with at least one embodiment;

FIG. 20 is another flowchart of an illustrative process for integrating a button assembly with an electronic device, in accordance with at least one embodiment;

FIG. 21A shows an illustrative perspective view of an electronic device including an integrable button and a rocker button, in accordance with at least one embodiment;

FIG. 21B shows an illustrative cross-sectional view of a portion of the electronic device of FIG. 21A, taken along line A-A of FIG. 21A, in accordance with at least one embodiment;

FIG. 21C shows a similar cross-sectional view of the portion of the electronic device of FIG. 21A, taken along line B-B of FIG. 21A, in accordance with at least one embodiment;

FIG. 21D shows an illustrative perspective view of a partial cross-section of the integrable button of FIG. 21A, in accordance with at least one embodiment;

FIGS. 21E-21G show various illustrative perspective views of the integrable button of FIG. 21A being installed into a housing, in accordance with at least one embodiment;

FIGS. 21H-21J show various illustrative perspective views of the rocker button of FIG. 21A being installed into a housing, in accordance with at least one embodiment;

FIG. 22 shows an illustrative flowchart for assembling a rocker button, in accordance with at least one embodiment;

FIG. 23 shows an illustrative perspective view of a partial cross-section of an alternate integrable button installed in a housing, in accordance with at least one embodiment;

FIG. 24 shows an illustrative perspective view of a partial cross-section of another alternate integrable button installed in a housing, in accordance with at least one embodiment;

FIG. 25 shows an illustrative perspective view of yet another alternate integrable button installed in a housing, in accordance with at least one embodiment;

FIGS. 26A and 26B show illustrative partial cross-sectional views of a portion of another electronic device having an alternate integrable button and an alternate rocker button, in accordance with at least one embodiment;

FIGS. 26C-26E show various illustrative perspective views of the integrable button of FIGS. 26A and 26B being installed into a housing of the electronic device, in accordance with at least one embodiment; and

FIGS. 26F-26H show various illustrative perspective views of the rocker button of FIGS. 26A and 26B being installed into the housing of the electronic device, in accordance with at least one embodiment.

### DETAILED DESCRIPTION OF THE PREFERRED EMBODIMENTS

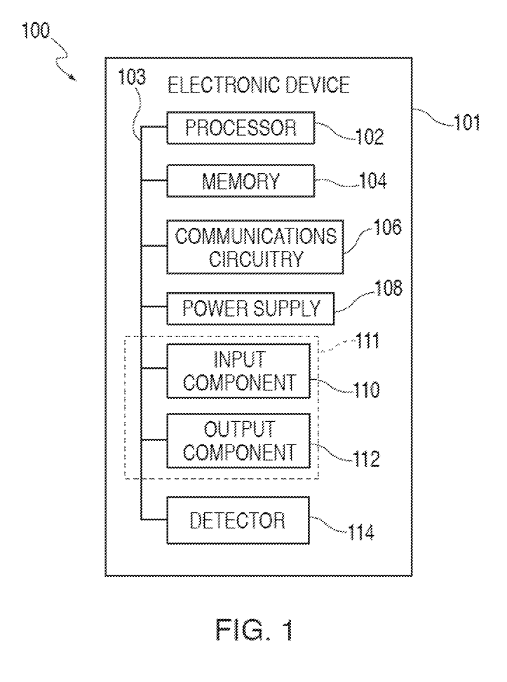

Systems and methods for providing inputs to an electronic device with a button assembly are provided and described with reference to FIGS. 1-26H.

FIG. 1 is a schematic view of an illustrative electronic device 100. In some embodiments, electronic device 100 may perform a single function (e.g., a device dedicated to storing image content) and, in other embodiments, electronic device 100 may perform multiple functions (e.g., a device that stores image content, plays music, and receives and transmits telephone calls). Moreover, in some embodiments, electronic device 100 may be any portable, mobile, or hand-held electronic device configured to control output of content. Alternatively, electronic device 100 may not be portable at all, but may instead be generally stationary. Electronic device 100 may include any suitable type of electronic device operative to receive user inputs. For example, electronic device 100 may include a media player (e.g., an iPod™ available by Apple Inc. of Cupertino, Calif.), a cellular telephone (e.g., an iPhone™ available by Apple Inc.), a personal e-mail or messaging device (e.g., a Blackberry™ available by Research In Motion Limited of Waterloo, Ontario), any other wireless communication device, a pocket-sized personal computer, a personal digital assistant (“PDA”), a tablet, a laptop computer, a desktop computer, a music recorder, a still camera, a movie or video camera or recorder, a radio, medical equipment, an accessory (e.g., headphones), any other suitable type of electronic device, and any combinations thereof.

Electronic device 100 may include a processor or control circuitry 102, memory 104, communications circuitry 106, power supply 108, input component 110, output component 112, and a detector 114. Electronic device 100 may also include a bus 103 that may provide a transfer path for transferring data and/or power, to, from, or between various other components of device 100. In some embodiments, one or more components of electronic device 100 may be combined or omitted. Moreover, electronic device 100 may include other components not combined or included in FIG. 1. For example, electronic device 100 may include motion detection circuitry, light sensing circuitry, positioning circuitry, or several instances of the components shown in FIG. 1. For the sake of simplicity, only one of each of the components is shown in FIG. 1.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may store media data (e.g., music, image, and video files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 106 may be provided to allow device 100 to communicate with one or more other electronic devices or servers using any suitable communications protocol. For example, communications circuitry 106 may support Wi-Fi (e.g., an 802.11 protocol), Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof. Communications circuitry 106 may also include circuitry that can enable device 100 to be electrically coupled to another device (e.g., a computer or an accessory device) and communicate with that other device, either wirelessly or via a wired connection.

Power supply 108 may provide power to one or more of the other components of device 100. In some embodiments, power supply 108 can be coupled to a power grid (e.g., when device 100 is not a portable device, such as a desktop computer). In some embodiments, power supply 108 can include one or more batteries for providing power (e.g., when device 100 is a portable device, such as a cellular telephone). As another example, power supply 108 can be configured to generate power from a natural source (e.g., solar power using solar cells).

One or more input components 110 may be provided to permit a user to interact or interface with device 100. For example, input component 110 can take a variety of forms, including, but not limited to, an electronic device pad, dial, click wheel, scroll wheel, touch screen, one or more buttons (e.g., a keyboard, volume control buttons, etc.), mouse, joy stick, track ball, a microphone, and combinations thereof. For example, input component 110 may include a multi-touch screen. Each input component 110 can be configured to provide one or more dedicated control functions for making selections or issuing commands associated with operating device 100.

Electronic device 100 may also include one or more output components 112 that may present information (e.g., textual, graphical, audible, and/or tactile information) to a user of device 100. Output component 112 of electronic device 100 may take various forms, including, but not limited, to audio speakers, in-ear earphones, headphones, audio line-outs, visual displays, antennas, infrared ports, rumblers, vibrators, or combinations thereof.

In some embodiments, output component 112 may include an audio output module that may be coupled to an audio connector (e.g., a male audio jack) for interfacing with an audio device (e.g., a headphone, an in-ear earphone, a microphone, etc.).

It should be noted that one or more input components 110 and one or more output components 112 may sometimes be referred to collectively herein as an I/O interface (e.g., input component 110 and output component 112 as I/O interface 111). It should also be noted that input component 110 and output component 112 may sometimes be a single I/O component, such as a touch screen that may receive input information through a user's touch of a display screen and that may also provide visual information to a user via that same display screen.

Detector 114 may include one or more sensors of any suitable type that may be utilized to detect a condition of the environment of device 100. In some embodiments, detector 114 may also include one or more sensors that may detect any human feature or characteristic (e.g., physiological, psychological, physical, movement, etc.). For example, detector 114 may include a microphone for detecting voice signals from one or more individuals. As another example, detector 114 may include a heartbeat sensor for detecting heartbeats of one or more individuals. As yet other examples, detector 114 may include a fingerprint reader, an iris scanner, a retina scanner, a breath sampler, and a humidity sensor that may detect moisture and/or sweat emanating from any suitable portion of an individual's body. For example, detector 114 may include a humidity sensor that may be situated near or coupled to one or more portions of input component 110, and that may detect moisture and/or sweat from an individual's hands. It should be appreciated that any detector 114 may include any sensor that may detect any human feature or characteristic.

In some embodiments, detector 114 may also include motion sensing circuitry for detecting motion of an environment of device 100 and/or objects in the environment. For example, the motion sensing circuitry may detect a movement of an object (e.g., an individual) about device 100 and may generate one or more signals based on the detection.

Processor 102 of device 100 may control the operation of many functions and other circuitry provided by device 100. For example, processor 102 may receive input signals from input component 110 and/or drive output signals through output component 112. Processor 102 may load a manager program (e.g., a program stored in memory 104 or another device or server accessible by device 100) to process or analyze data received via detector 114 or inputs received via input component 110 to control output of content that may be provided to the user via output component 112 (e.g., a display).

Electronic device 100 may also be provided with a housing 101 that may at least partially enclose one or more of the components of device 100 for protecting them from debris and other degrading forces external to device 100. Housing 101 may be composed of any suitable type of material (e.g., aluminum). In some embodiments, one or more of the components may be provided within its own housing (e.g., input component 110 may be an independent keyboard or mouse within its own housing that may wirelessly or through a wire communicate with processor 102, which may be provided within its own housing).

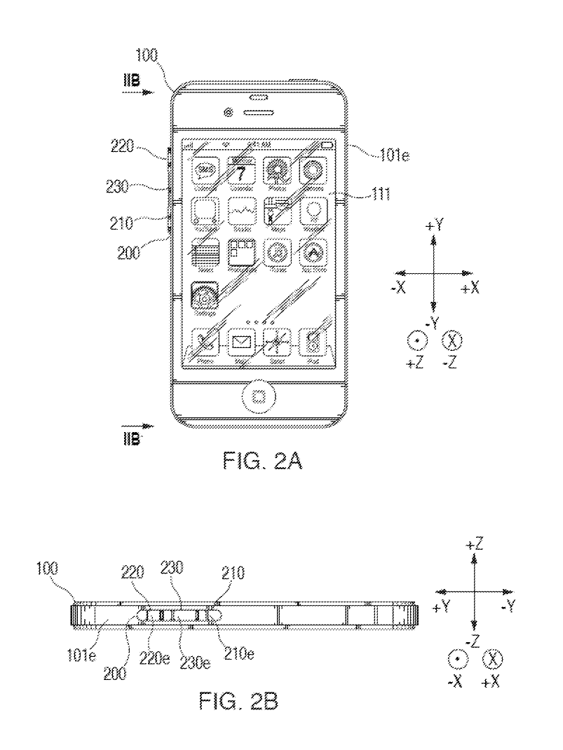

FIGS. 2A and 2B, for example, show various portions of electronic device 100. As shown in FIG. 2A, for example, electronic device 100 may include housing 101 and I/O interface 111. I/O interface 111 may, for example, include a single touch screen component.

In some embodiments, electronic device 100 may include separate input mechanisms or buttons, each one being dedicated to manipulate the electronic device in a certain way. For example, a first button may be dedicated for powering the electronic device ON or OFF. As another example, a separate second button may be dedicated for increasing a volume setting of the electronic device, and a separate third button may be dedicated for decreasing the volume setting. Employing a number of such buttons may complicate and increase the cost of manufacture of the electronic device. Thus, in other embodiments, it may be advantageous to provide fewer input mechanisms or buttons that may provide users with the same ability to manipulate the electronic device.

In some embodiments, electronic device 100 may include a button assembly 200 that may be disposed on a side portion of housing 101. Button assembly 200 may, for example, be a part of an input component 110 of electronic device 100. Button assembly 200 may include a center region 230 and two end regions 210 and 220. In some embodiments, each one of regions 210, 220, and 230 may exist as separate components that may be coupled to form button assembly 200. In these embodiments, for example, regions 210, 220, and 230 may be connected in a contiguous manner. That is, there may be no physical discontinuities from end region 210 to center region 230, and from center region 230 to end region 220. In other embodiments, button assembly 200 may be constructed as a single structure (e.g., from a single piece of material). In these embodiments, button assembly 200 may not be physically formed from separable regions (e.g., such as regions 210, 220, and 230). Rather, certain portions of button assembly 200 may be distinguished from one another based on, for example, a difference in one or more of their respective physical characteristics. In yet other embodiments, button assembly 200 may include fewer or more regions. For example, rather than including three regions 210, 220, and 230, button assembly 200 may only include two regions (e.g., center region 230 and any one of end region 210 and 220). As another example, rather than including only three regions 210, 220, and 230, button assembly 200 may include one or more extra regions that may each be similar to any one of center region 230 and end regions 210 and 220.

As shown in FIG. 2B, for example, button assembly 200 may be disposed through housing 101 such that each one of a front surface 230f of center region 230, a front surface 210f of end region 210, and a front surface 220f of end region 220 may face away from electronic device 100 (e.g., away from device 100 through an opening in external surface 101e of housing 101) in a −X-direction of FIG. 2A. Although center region 230 and end regions 210 and 220 may form a single button assembly 200, each one of these regions may be configured as a single input mechanism or button that may activate a respective function of electronic device 100. For example, end region 220 may be configured as an input for a volume increase function of electronic device 100 (e.g., a volume setting of electronic device 100 may increase when front surface 220f of end region 220 is depressed in the +X-direction of FIG. 2A). As another example, end region 210 may be configured as an input for a volume decrease function of electronic device 100 (e.g., a volume setting of electronic device 100 may decrease when front surface 210f of end region 210 is depressed in the +X-direction of FIG. 2A). As yet another example, center region 230 may be configured as an input for any other suitable function of electronic device 100 (e.g., a particular setting or function of electronic device 100 may be controlled or affected when front surface 230f of center region 230 is depressed in the +X-direction of FIG. 2A).

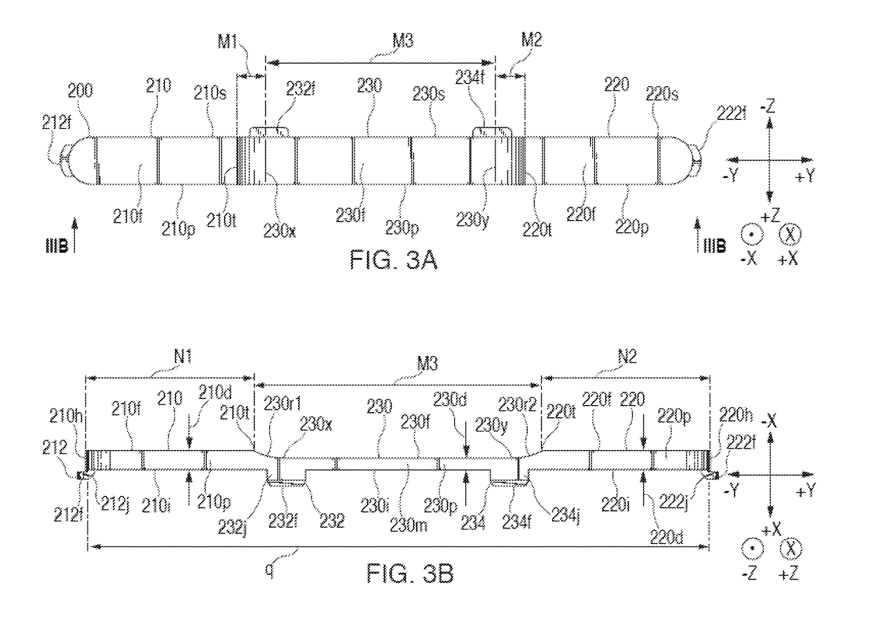

FIGS. 3A and 3B, for example, show various portions of button assembly 200. Button assembly 200 may be composed of any suitable material (e.g., 6063 aluminum). As shown in FIG. 3A, and as briefly described above with respect to FIGS. 2A and 2B, for example, button assembly 200 may include center region 230 and end regions 210 and 220. Center region 230 may include a front surface 230f, side surfaces 230s and 230p, and an internal surface 230i. Similarly, end region 210 may include front surface 210f, side surfaces 210s and 210p, and an internal surface 210i, and end region 220 may include front surface 220f, side surfaces 220s and 220p, and an internal surface 220i. When button assembly 200 is integrated with electronic device 100 (e.g., as shown in FIGS. 2A and 2B), for example, side surfaces 230s, 210s, and 220s may each face the +Z-direction of FIG. 2A, side surfaces 230p, 210p, and 220p may each face the −Z-direction of FIG. 2A, and internal surfaces 230i, 210i, and 220i may each face the +X-direction of FIG. 2A.

In some embodiments, button assembly 200 may vary in physical characteristics from region to region. For example, end region 210 may have a predefined thickness 210d (e.g., 0.6 millimeters to 0.7 millimeters) that may extend from front surface 210f to internal surface 210i, and end region 220 may have a predefined thickness 220d (e.g., 0.6 millimeters to 0.7 millimeters) that may similarly extend from front surface 220f to internal surface 220i. In some embodiments, predefined thickness 210d may be equal to predefined thickness 220d. However, a thickness of center region 230 may vary from one end of center region 230 (e.g., at line 210t) to another end of center region 230 (e.g., at line 220t). As shown in FIG. 3B, for example, end region 210 may extend from end 210h to line 210t, and end region 220 may extend from end 220h to line 220t. Further, front surfaces 210f and 220f, and internal surfaces 210i and 220i may each be substantially flat. In this manner, the thicknesses 210d and 220d may be substantially constant throughout the entireties of end regions 210 and 220, respectively. Front surface 230f and internal surface 230i of center region 230 may also be substantially flat (e.g., from a line 230x to a line 230y). However, center region 230 may include a curved portion 230r1, which may extend from line 210t to line 230x, and a curved portion 230r2, which may extend from line 220t to line 230y. Curved portions 230r1 and 230r2 may vary in thickness from line 210t to 230x and from line 220t to line 230y, respectively. Curved portion 230r1 may have a thickness 210d at line 210t, but may gradually decrease in thickness until line 230x, which may, for example, have thickness 230d (e.g., 0.32 millimeters). Curved portion 230r2 may be substantially similar (e.g., physically) to curved portion 230r1. For example, curved portion 230r2 may have a thickness 220d at line 220t, but may gradually decrease in thickness until line 230y, which may, for example, have thickness 230d. Curved portion 230r1 may extend for a length m1, and may curve at any suitable radius. Similarly, curved portion 230r2 may extend for a length m2 (e.g., that may be equal to m1), and may curve at any suitable radius (e.g., at the same radius as that of curved portion 230r1). The curved configuration of curved portions 230r1 and 230r2 may, for example, allow a user to tactilely distinguish center region 230 and end regions 210 and 220 from one another (e.g., when a user brushes one or more fingers over button assembly 200).

In some embodiments, button assembly 200 may vary in physical flexibility from region to region. This variation may, for example, be due to the difference between the smaller thickness 230d of center region 230 and each one of the larger thicknesses 210d and 220d of end regions 210 and 220, respectively. For example, end regions 210 and 220 may each be composed of a certain material or combination of materials (e.g., aluminum) and may each have the same flexibility (e.g., hardness, stiffness, etc.), whereas center region 230 may also be composed of the same material or combination of materials, but may be more flexible than any one of end regions 210 and 220. That is, a flexibility of at least a portion of center region 230 may be greater than a flexibility of any portion of either one of end regions 210 and 220. This variation in physical flexibility may allow each one of end regions 210 and 220, and center region 230 to essentially function as a separate input mechanism or button. In some embodiments, the flexibility of each one of end regions 210 and 220 and center region 230 may not be constant throughout that region, but may, for example, vary continuously throughout that region (e.g., according to a predefined design requirements). For example, each one of end regions 210 and 220 and center region 230 may have a predefined flexibility profile (e.g., a first flexibility at a first portion of that region, a second flexibility at a second portion of that region, etc.). As described above with respect to FIGS. 2A and 2B, in some embodiments, rather than being formed from separable regions (e.g., such as regions 210, 220, and 230), button assembly 200 may instead be distinguished from one another based on a difference in one or more of their respective physical characteristics. In these embodiments, certain portions (e.g., that may correspond to end regions 210 and 220 and center region 230) of button assembly 200 may be distinguished from one another based on a difference in their respective flexibilities or flexibility profile. Moreover, in some embodiments, each one of regions 210, 220, and 230 may or may not vary in flexibility or be flexible at all, but may instead be coupled to one another via one or more coupling components (not shown) that may be flexible. In these embodiments, the flexibility of such coupling components may, for example, allow a user to distinguish between each one of regions 210, 220, and 230. Additionally, in embodiments where button assembly 200 may be constructed as a single structure or a single button (e.g., as described above), button assembly 200 may include one or more features (e.g., a weakening feature, such as a slit, a perforation, etc.) that may each provide flexibility between certain portions of button assembly 200 on opposite sides of that feature. In these embodiments, for example, the flexibility of such features may allow a user to distinguish between each one of regions 210, 220, and 230.

As shown in FIGS. 3A and 3B, for example, button assembly 200 may be in its natural state. Button assembly 200 may be in its natural state, for example, when no external force (e.g., in the +X-direction) is applied to any portion of any one of front surfaces 210f, 220f, and 230f. In some embodiments, the entirety of center region 230 may be flexible. In these embodiments, when an external force is applied to one or more portions of any one of front surfaces 210f, 220f, and 230f, button assembly 200 may change (e.g., bend) from its natural state. For example, while each one of center region 230 and end regions 210 and 220 is at least partially fixed in place with respect to housing 101 (e.g., via at least one limb that may latch onto or interact with a corresponding portion of housing 101, as described below), center region 230 may bend with respect to either one of end regions 210 and 220, when an external force is applied to an appropriate portion of one of front surfaces 210f, 220f, and 230f. In other embodiments, only curved portions 230r1 and 230r2 may be more flexible than any one of end regions 210 and 220. In these embodiments, the portion of center region 230 that may extend from line 230x to 230y may have the same hardness or stiffness as each one of end regions 210 and 220. In this configuration, each one of curved portions 230r1 and 230r2 may act as a pivot that may allow center region 230 to bend with respect to corresponding end regions 210 and 220. That is, while each one of center region 230 and end regions 210 and 220 is at least partially fixed in place with respect to housing 101 (e.g., via at least one limb that may latch onto or interact with a corresponding portion of housing 101, as described below), center region 230 may bend with respect to corresponding end regions 210 and 220, when an external force is applied to an appropriate portion of one of front surfaces 210f, 220f, and 230f.

Center region 230 may have a length n3, and end regions 210 and 220 may have lengths n1 and n2, respectively. In some embodiments, length n3 may be equal to a sum of length n1, length n2, and a length m3 of FIG. 3A. Length n₁ may be equal to length n2. Button assembly 200 may have a total length of q, which may be the sum of lengths n1, n2, and n3. In some embodiments, button assembly 200 may be rotationally symmetric. For example, length n1 may be equal to length n2, and a length of a portion of center region 230 (e.g., that may extend from line 210t to a midpoint 230m of center region 230) may be equal to a length of another portion of center region 230 (e.g., that may extend from line 220t to midpoint 230m).

In some embodiments, button assembly 200 may also include a set of limbs that may each be configured to secure to a corresponding portion of electronic device 100. As shown in FIG. 3B, for example, button assembly 200 may include a limb 212 that may extend from internal surface 210i at end 210h of end region 210, and a limb 222 that may extend from internal surface 220i at end 220h of end region 220. Button assembly may also include limbs 232 and 234 that may each extend from internal surface 230i of center region 230. Each of limbs 212, 222, 232, and 234 may include a corresponding leg and a foot. For example, limb 212 may include a leg 212j that may protrude from internal surface 210i, and that may lead to a foot 212f, and limb 222 may include a leg 222j that may protrude from internal surface 220i, and that may lead to a foot 222f. Each of legs 212j and 222j may, for example, protrude from internal surfaces 210i and 220i, respectively, in the +X-direction. Moreover, as shown in FIGS. 3A and 3B, foot 212f may point in the −Y-direction and foot 222f may point in the +Y-direction. Similarly, each of legs 232j and 234j may, for example, protrude from internal surface 230i in the +X-direction. Moreover, each one of feet 232f and 234f may, instead, be pointing in the −Z-direction (e.g., into the page).

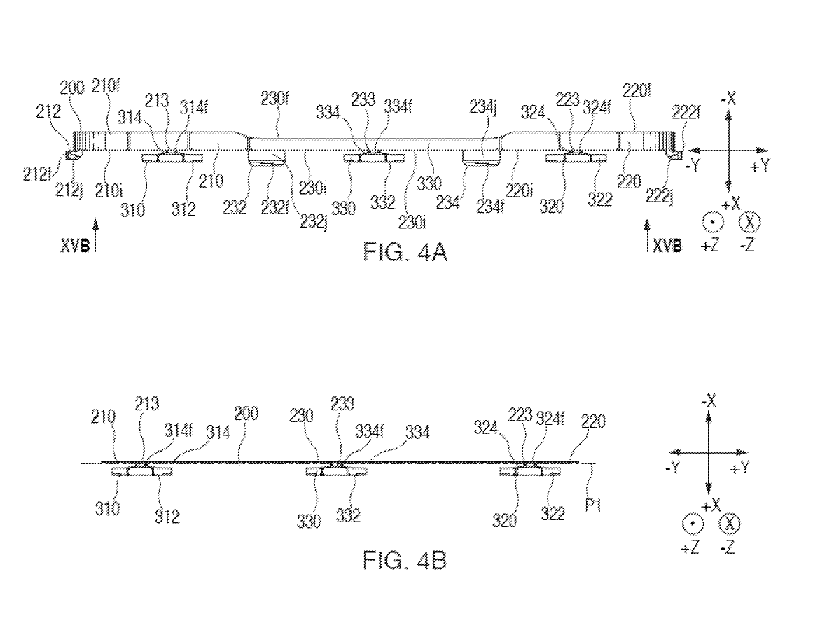

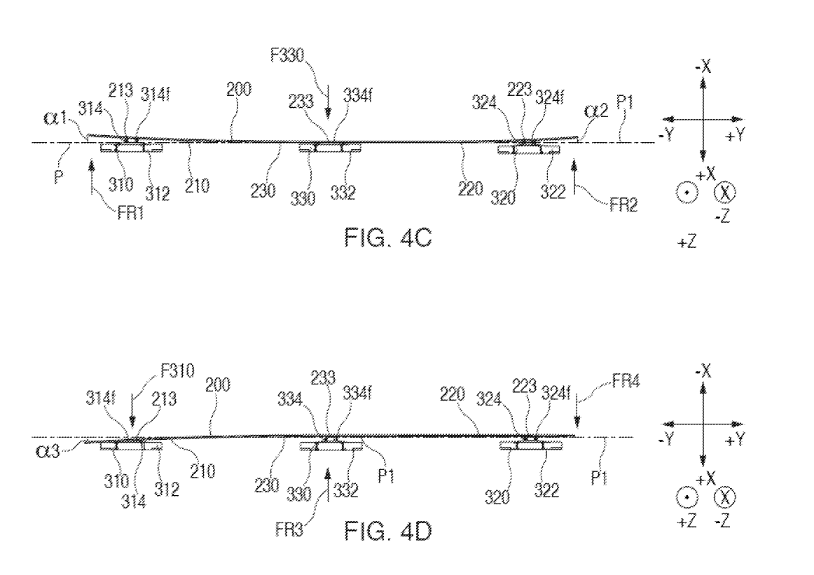

FIG. 4A, for example, shows button assembly 200 being disposed adjacent to a set of switches 310, 320, and 330. Switches 310, 320, and 330 may each be disposed at a predefined location within electronic device 100 (e.g., within housing 101 underneath button assembly 200). Moreover, switches 310, 320, and 330 may, in some embodiments, be secured in their respective predefined locations via one or more support brackets (e.g., as described with respect to FIG. 14). Switches 310, 320, and 330 may, for example, be similar to one another, and may include any suitable type of switch (e.g., a pushbutton switch). For example, each one of switches 310, 320, and 330 may include a corresponding frame 312, 322, and 332, respectively, and a corresponding activator 314, 324, and 334, respectively. Each one of activators 314, 324, and 334 may be configured to depress (e.g., into the corresponding frame), when a force is applied thereon (e.g., by button assembly 200). Moreover, each one of activators 314, 324, and 334 may be configured to underpass (e.g., protrude from the corresponding frame, as shown, for example, in FIG. 4A), when no force is applied thereon. Hence, each one of switches 310, 320, and 330 may be capable of occupying a depressed state (e.g., when its corresponding activator is depressed), and a natural state (e.g., when its corresponding activator is not being depressed). As shown in FIG. 4A, for example, each one of switches 310, 320, and 330 may be in its natural state (e.g., when no external force is applied to a corresponding one of activator surfaces 314f, 324f, and 334f of switches 310, 320, and 330). In some embodiments, when no external force is applied to any portion of any one of front surfaces 210f, 220f, and 230f of button assembly 200, each one of button assembly 200 and switches 310, 320, and 330 may be in their respective natural states. In these natural states, each one of portions 213, 223, and 233 of button assembly 200 may be flush or in contact with a corresponding one of activator surfaces 314f, 324f, and 334f. In other embodiments, when no external force is applied to any portion of any one of front surfaces 210f, 220f, and 230f, a respective gap (not shown) may exist between each one of portions 213, 223, and 233 and a corresponding one of activator surfaces 314f, 324f, and 334f. Switches 310, 320, and 330 may also include corresponding circuitry (not shown) that may be disposed within their respective frames 312, 322, and 332. Each circuitry may, for example, be configured to output an electrical signal each time a corresponding one of activators 314, 324, or 334 is depressed. As shown in FIG. 4A, for example, each one of switches 310, 320, and 330 (e.g., each one of activators 314, 324, and 334) may be in its respective natural state. For example, a portion 213 of end region 210 along surface 210i may be disposed adjacent to activator surface 314f of activator 314 (e.g., when activator 314 is in its natural state) along surface 220i, a portion 223 of end region 220 may be disposed adjacent to activator surface 324f of activator 324 (e.g., when activator 324 is in its natural state) along surface 230i, and a portion 233 of center region 230 may be disposed adjacent to activator surface 334f of activator 334 (e.g., when activator 334 is in its respective natural state). When an external force is applied to any one of activator surfaces 314f, 324f, and 334f, a corresponding one of activators 312, 324, or 334 may transition from its natural state to a depressed stated (e.g., depressed in the +X-direction into a cavity (not shown) of a corresponding one of frames 312, 322, and 332). For example, when an external force is applied (e.g., by a finger of a user of device 100) in the +X-direction onto a portion of any one of front surfaces 210f, 220f, and 230f, a corresponding one of portions 213, 223, and 233 may exert a similar force onto a corresponding one of activator surfaces 314f, 324f, and 334f. This may, as a result, cause that activator to depress in the +X-direction.

FIGS. 4B-4D, for example, show button assembly 200 and switches 310, 320, and 330 occupying various states. In particular, FIGS. 4B-4D may show simplified representations of button assembly 200 of FIG. 4A. As shown in FIG. 4B, for example, button assembly 200 may be in its natural state. In its natural state, button assembly 200 may be substantially parallel with a horizontal line P1 (e.g., a line that may run along the top surfaces of switches 310, 320, and 330 in their natural states). Moreover, each one of switches 310, 320, and 330 may be in its natural state (e.g., similar to the natural state of switches 310, 320, and 330 described above with respect to FIG. 4A).

As described above with respect to FIGS. 3A and 3B, because curved portions 230r1 and 230r2 of button assembly 200 may be more flexible than end regions 310 and 320, button assembly 200 may change from its natural state (e.g., center region 230 may bend with respect to each one of end regions 310 and 320), when a force is applied to one or more appropriate portions of button assembly 200 (e.g., front surface 230f of center region 230). As shown in FIG. 4C, for example, button assembly 200 may be subjected to a force F330 (e.g., a force that may be applied by a user in order to depress switch 330) at portion 233 of center region 230 (e.g., at a portion of center region 230 along surface 230f). As a result, center region 230 may bend with respect to each one of end regions 210 and 220 in the +X-direction. Because regions 210, 220, and 230 may contiguously form button assembly 200, the bending of center region 230 in the +X-direction may force each one of end regions 210 and 220 to move in the −X-direction. More particularly, the bending of center region 230 in the +X-direction may result in a force Fr1 being applied to end region 210 in the −X-direction and a force Fr2 being applied to end region 220 in the −X-direction. As shown in FIG. 4C, for example, forces Fr1 and Fr2 may cause respective end regions 210 and 220 to move with respect to horizontal line P1, and away from a corresponding one of activator surfaces 314f and 324f. In particular, end region 210 may move or bend with respect to horizontal line P1 at an angle α1, and end region 220 may move or bend with respect to horizontal line P2 at an angle α2 (e.g., which may be similar or equal to angle α1). In contrast, force F330 may cause center region 230 to contact activator surface 334f of activator 334 and depress activator 334 in the +X-direction into frame 332. As a result, switch 330 may be activated, and switches 310 and 320 may remain in their respective natural states (e.g., un-depressed states). In this manner, a particular region (e.g., center region 230) of button assembly 200 may function as an individual input mechanism or button for electronic device 100.

As shown in FIG. 4D, for example, button assembly 200 may be subjected to a force F310 (e.g., that may be applied by a user in order to depress switch 310) at portion 213 of end region 210 (e.g., along surface 210f of end region 210). In the presence of force F310, end region 210 may move in the +X-direction such that portion 213 may contact activator surface 314f and depress activator 314 in the +X-direction. The movement of end region 210 may form an angle α3 with respect to horizontal line P1. Moreover, center region 230 may bend with respect to end region 210 in the +X-direction (e.g., due to the flexible configuration of curved portion 230r1). Because regions 210, 220, and 230 may contiguously form button assembly 200, the bending of center region 230 (e.g., in the +X-direction with respect to end region 210 may force the contiguous regions of center region 230 and end region 220 to move towards the +X-direction. In particular, the combined weights of center region 230 and end region 220 may result in a reactionary force Fr4 that may force center region 230 and end region 220 to move in the +X-direction. This movement may, for example, make button assembly 200 appear to be in a bowed state.

In addition, a reactionary force Fr3 may be applied by activator surface 334f (e.g., via activator 334) onto portion 233 of center region 230. In particular, the movement of center region 230 in the +X-direction may be sufficient make contact between portion 233 and activator surface 334f. However, button assembly 200 may be configured such that this contact may not be sufficient to depress activator 334 in the +X-direction. Thus, in some embodiments, activator 334 may act as a pivot that may prevent portion 423 from contacting activator surface 324f. In other embodiments, activator 334 may act as a pivot that may allow portion 423 to contact activator surface 324f, but may prevent portion 423 from actually depressing activator 324 in the +X-direction. As a result, switch 310 may be depressed, and switches 320 and 330 may remain in their respective natural states (e.g., un-depressed). In this manner, another region (e.g., end region 210) of button assembly 200 may also function as another individual input mechanism or button for electronic device 100.

It should be appreciated that, although FIG. 4D may only show end region 310 having a force F310 applied thereon, end region 320 rather than end region 310 may, instead, have a similar force applied thereon. In this scenario, button assembly 200 may bend similarly as shown in FIG. 4D, but end region 220 may move toward the +X-direction (e.g., due to the flexible configuration of curved portion 230r2) and portion 423 may contact activator surface 324f and depress activator 324 in the +X-direction. Moreover, center region 230 and end region 210 may reside above corresponding switches 330 and 310, respectively.

Although FIGS. 4C and 4D may show forces F330 and F310 being applied to specific portions of button assembly 200, each one of forces F330 and F310 may, instead, be applied to any other suitable portion of center region 230 and end region 210, respectively, as long as a desired switch (e.g., switch 330, as shown in FIG. 4C, and switch 310, as shown in FIG. 4D) may be activated, and the remaining switches may remain in their respective natural states (e.g., switches 310 and 320, as shown in FIG. 4C, and switches 320 and 330, as shown in FIG. 4D).

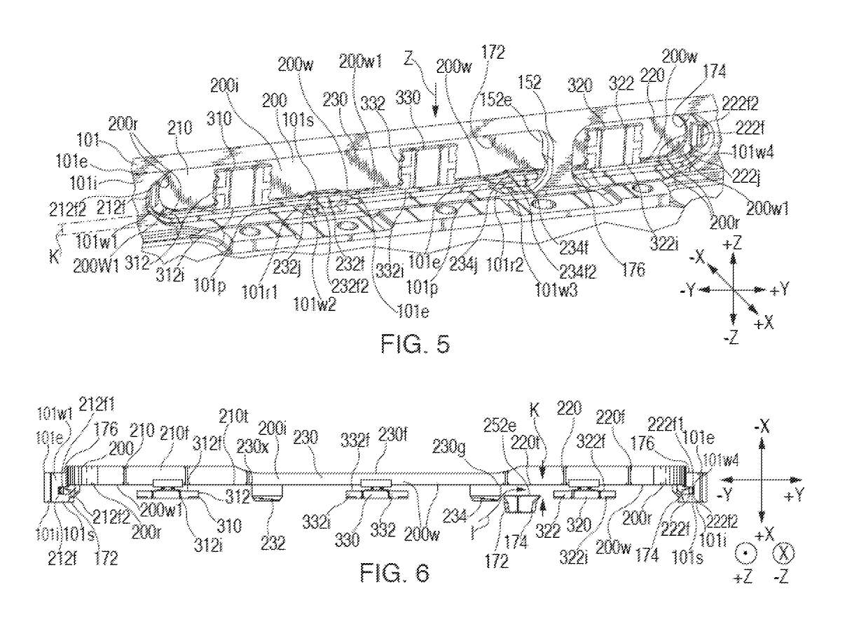

As shown in FIGS. 5 and 6, for example, button assembly 200 may be coupled to electronic device 100 (e.g., similar to what is shown in FIGS. 2A and 2B) via a portion of housing 101. Housing 101 may include a structural post 152 that may enhance the structural integrity of housing 101 (e.g., at least in the Z-direction). Housing 101 may include external surface 101e and an internal surface 101i. External surface 101e may include an external opening 176. Internal surface 101i may include internal openings 172 and 174. Internal opening 172 may be larger than internal opening 174, and may, for example, be separated from internal opening 174 by structural post 152. Hence, external opening 176 may be larger than a combination of internal openings 172 and 174. Moreover, external opening 176 may be fluid with openings 172 and 174. Button assembly 200 may be disposed within external opening 176. As shown in FIG. 6, for example, button assembly 200 may be disposed over external opening 176 such that the portion of center region 230, that may extend from line 230x to 230y, may be parallel to external surface side 101e of housing 101. In some embodiments, external surface side 101e may not be entirely flat or planar as depicted in FIGS. 2A and 2B, but may instead include a portion that may be at least partially indented in the +X-direction (e.g., with respect to the rest of external surface side 101e) in the vicinity leading to external opening 176. In these embodiments, button assembly 200 may protrude from this indented portion of external surface side 101e in the −X-direction. In this manner, at least a portion of each one of side surfaces 210s, 210p, 220s, 220p, 230s, and 230p of button assembly 200 may be exposed outside of housing 101. This configuration may, for example, provide a user with improved tactility of the various regions of button assembly 200 with respect to housing 101.

As shown in FIG. 5, for example, button assembly 200 may be oriented such that an inner surface 200i (e.g., a combination of internal surfaces 210i, 220i, and 230i) of button assembly 200 may face the inside of housing 101. Although button assembly 200 may have been described above as having separate and substantially flat surfaces 210i, 220i, and 230i, in some embodiments, the inner surface 200i of button assembly 200 may be a contiguous flat surface. Moreover, inner surface 200i may not span the entire length q of button assembly 200, but may be surrounded by a wall 200w. As shown in FIG. 5, for example, button assembly 200 may include wall 200w and a recess 200r. Wall 200w and inner surface 200i may, for example, each extend in the X-direction of FIG. 6 to form the various thicknesses of center region 230 and end regions 210 and 220. Recess 200r may extend from inner surface 200i to a wall surface 200w1. When button assembly 200 is coupled to housing 101, for example, recess 200r may reside entirely within housing 101. Surface 200i may be substantially flat throughout the entirety of recess 200r (e.g., from end region 210 to center region 230, and from center region 230 to end region 220). In some embodiments, button assembly 200 may not include recess 200r, but may instead include an entirely flat surface throughout surface 200i of button assembly 200. In these embodiments, button assembly 200 may, for example, be composed of a more flexible material (e.g., plastic) or be positioned farther within housing 101 in the +X-direction.

As shown in FIG. 5, for example, button assembly 200 may be secured within housing 101 via the set of limbs 212, 222, 232, and 234. In particular, foot 212f of limb 212 may contact or interface with a wall portion 101w1 of housing 101. For example, in some embodiments, foot 212f may releasably couple to wall portion 101w1 by hooking or latching, via front surface 212f1, onto wall portion 101w1, when end region 210 is aligned with external surface 101e of housing 101. Alternatively, foot 212f may contact (e.g., passively) surface 101i of wall portion 101w1. Similarly, foot 222f of limb 222 may contact or interface with a wall portion 101w4 of housing 101 via front surface 222f1 of foot 222f. For example, foot 222f may releasably couple to wall portion 101w4 by hooking or latching onto wall portion 101w4, when end region 220 is aligned with external surface 101e of housing 101. Each of limbs 232 and 234 may secure to housing 101 via feet 232f and 234f, respectively. In particular, leg 232j of limb 232 may extend along a portion of a side surface 101p (e.g., about external opening 176) such that foot 232f may hook or latch onto a wall portion 101w2 of a recess portion 101r1 of housing 101. Leg 234j of limb 234 may similarly extend along another portion of surface 101p of housing 101 (e.g., about external opening 176) such that foot 234f may hook or latch onto a wall portion 101w3 of a recess 101r2 of housing 101. In this manner, wall portions 101w1-101w4 may prevent button assembly 200 from moving in a direction away from housing 101 (e.g., the −X-direction out of housing 101 through external opening 176).

Although wall portions 101w1-101w4 may prevent button assembly 200 from moving in a direction away from housing 101 (e.g., the −X-direction), in some embodiments, wall portions 101w1-101w4 may not be configured to prevent button assembly 200 from moving farther into electronic device 100 (e.g., in the +X-direction due to any of forces F310 and F330). For example, housing 101 may not include any structural barriers opposite to any one of wall portions 101w1-101w4. That is, housing 101 may not include any structural barriers that may prevent any one of feet surfaces 212f, 222f, 232f, and 234f from moving in the +X-direction within housing 101. Instead, housing 101 may include space 101s that may be positioned directly below each one of wall portions 101w1-101w4, such that each one of limbs 212, 222, 232, and 234 may be free to move away from a corresponding one of wall portions 101w1-101w4 and farther into electronic device 100 (e.g., in the +X-direction). Moreover, in some embodiments, structural post 152 of housing 101, which may be disposed within housing 101 underneath external opening 176, also may not be configured to prevent button assembly 200 from moving at least some distance farther into electronic device 100. For example, structural post 152 may be positioned a predefined distance k from external surface 101e, such that no portion (e.g., not even surface 200i) of button assembly 200 may be in contact with an external surface 152e of structural post 152. Thus, when switches 310, 320, and 330 are fixed in place within housing 101 (e.g., as shown in FIGS. 5 and 6), switches 310, 320, and 330 may be the only barriers that may prevent button assembly 200 from moving farther into electronic device 100 in the +X-direction.

As described above with respect to FIG. 4C, for example, when external force F330 is applied to portion 233 of button assembly 200, reactionary forces Fr1 and Fr2 may be produced. Due to these reactionary forces, each one of feet 212f and 222f of button assembly 200 may, for example, attempt to move in the −X-direction. However, because foot 212f may already be hooking, latching, contacting, or otherwise interacting with wall portion 101w1, and because foot 222f may already be hooking, latching, contacting, or otherwise interacting with wall portion 101w4, reactionary forces Fr1 and Fr2 may not actually move feet 212f and 222f in the −X-direction, but may instead strengthen the interaction thereof with the corresponding wall portion of housing 101.

As shown in FIGS. 5 and 6, for example, switches 310, 320, and 330 may be disposed such that surfaces 312i, 322i, and 332i, respectively, may face the inside of housing 101 (e.g., in the +X-direction), and surfaces 312f, 322f, and 322f, respectively, may face away from housing 101 (e.g., in the −X-direction). Each one of surfaces 312f, 322f, and 332f may, for example, be substantially parallel to surface 200i, and may prevent corresponding portion (e.g., center region 230, end region 210, and end region 220) of button assembly 200 from entering farther into housing 101 and beyond switches 310, 320, and 330. In addition, although structural post 152 may be positioned the predefined distance k underneath external surface 101e of housing 101, structural post 152 may also prevent button assembly 200 from entering into housing 101 and beyond structural post 152 (e.g., in the event that any one of switches 310, 320, and 330 is no longer fixed in place within housing 101).

As shown in FIGS. 5 and 6, for example, each one of limbs 212, 222, 232, and 234 of button assembly 200 may protrude in the +X-direction, towards the inside of electronic device 100 such that each one of the respective feet 212f, 222f, 232f, and 234f may hook, latch, or otherwise interact with a corresponding portion of housing 101. To properly align each one of limbs 212, 222, 232, and 234 (and thus, feet 212f, 222f, 232f, and 234f) to the corresponding portions of electronic device 100, button assembly 200 may be integrated with housing 101 by first positioning button assembly 200 within housing 101 (e.g., inside of electronic device 100). For example, while the portion of housing 101 shown in FIGS. 5 and 6 is made accessible, button assembly 200 may first be positioned within housing 101. Button assembly 200 may, for example, be positioned within housing 101 with each one of surfaces 210f, 220f, and 230f facing the −X-direction. End region 220 may then be moved in the −X-direction and the +Y-direction (e.g., in the direction of arrow I) around external surface 152e of structural post 152 until end 220h is aligned with an end of external opening 176 and foot 222f is aligned with wall portion 101w4. It should be appreciated that the flexibility of center region 230 may allow the movement of end region 220 around structural post 152 described above. Subsequently, the remainder of button assembly 200 may be aligned with corresponding portions of external opening 176, and the remaining feet of button assembly 200 may be aligned with the corresponding portions of housing 101 (e.g., as described above).

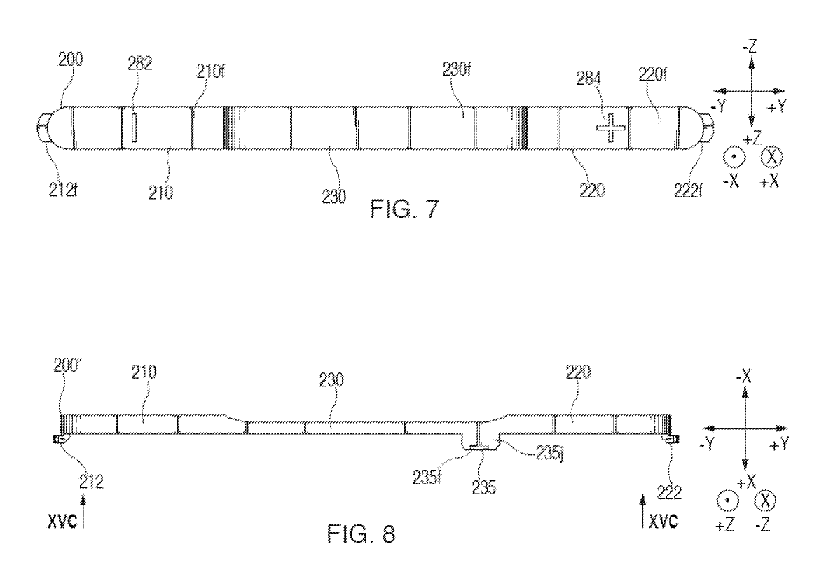

Although button assembly 200 may be shown (e.g., in FIGS. 2A and 3A) and described above as being substantially free of markings, in some embodiments, portions of button assembly 200 may include one or more indicators or markings. For example, as shown in FIG. 7, front surface 210f of end region 210 may include a marking 282, and front surface 220f of end region 220 may include a marking 284. As described above with respect to FIGS. 2A and 2B, end region 220 may, for example, be configured as an input for a volume increase function of electronic device 100 (e.g., a volume setting of electronic device 100 may increase when front surface 220f of end region 220 is depressed in the +X-direction of FIG. 2A), and thus marking 284 may be a “+” symbol. Moreover, end region 210 may be configured as an input for a volume decrease function of electronic device 100 (e.g., a volume setting of electronic device 100 may decrease when front surface 210f of end region 210 is depressed in the +X-direction of FIG. 2A), and thus marking 282 may be a “−” symbol. In some embodiments, each one of front surfaces 210f and 220f may be computer numeric control (“CNC”) cut to form markings 282 and 284, respectively. In other embodiments, markings 282 and 284 may each be etched (e.g., via laser etching or any other suitable form of etching) onto front surfaces 210f and 220f, respectively. In yet other embodiments, each one of front surfaces 210f and 220f may be polished or surface finished to form markings 282 and 284. It should be appreciated, that although front surface 230f of center region 230 may not be shown to include any markings, front surface 230f may also include a marking that may be similar to any one of markings 282 and 284. Moreover, in some embodiments, center region 230 (e.g., front surface 230f) may visually distinguish from each one of end regions 210 and 220 (e.g., front surfaces 210f and 220f, respectively). For example, front surfaces 210f and 220f may each be surface finished in one manner (e.g., bead blasted), and front surface 230f may be surface finished in different manner (e.g., polished). The difference in visual characteristics between front surface 230f and front surfaces 210f and 220f may, for example, allow a user to easily discern the locations of each of regions 210, 220, and 230.

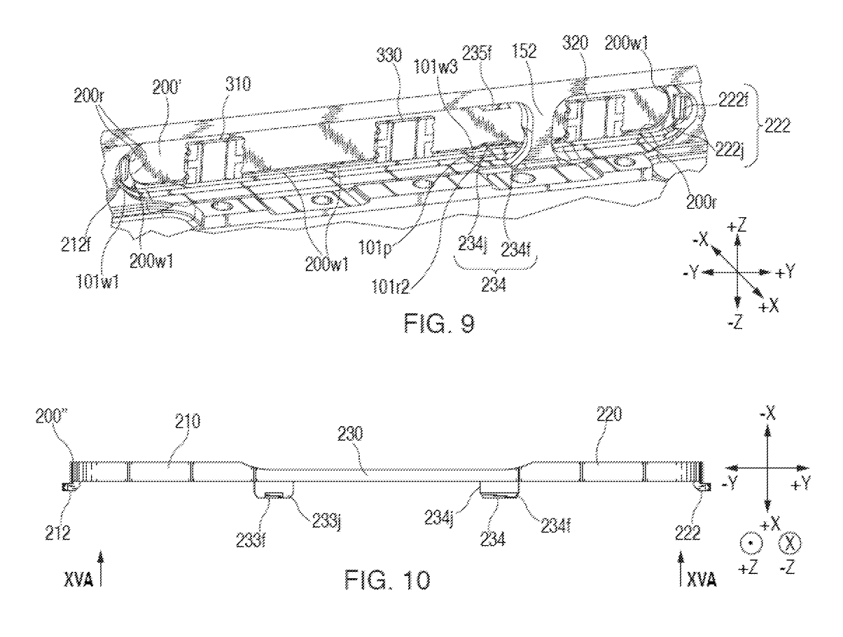

Although button assembly 200 has been shown (e.g., in FIGS. 2A and 3A) and described above as having limbs (e.g., limbs 232 and 234) positioned in specific locations (e.g., both of limbs 232 and 234 being positioned adjacent a single side surface 230s of button assembly 200), in some embodiments, a button assembly may, instead, include one limb adjacent side surface 230s and another limb adjacent side surface 230p. As shown in FIGS. 8 and 9, for example, button assembly 200′ may be the same as button assembly 200, but may include an alternative limb configuration. In particular, button assembly 200′ may include center region 230, end regions 210 and 220, and all the features thereof that have been described above with respect to FIGS. 2A-7. Button assembly 200′ may also include limbs 212 and 222. Moreover, button assembly 200′ may also include limb 234 adjacent side surface 230s. However, rather than including limb 232 adjacent side surface 230s (e.g., as with button assembly 200), button assembly 200′ may include a limb 235 on side surface 230p. For example, limb 235 may be positioned adjacent to limb 234, in the +Z-direction of FIG. 8. Limb 235 may include a leg 235j that may be similar to leg 234j, and that may protrude from button assembly 200 in the +X-direction of FIG. 8. Limb 235 may also include a foot 235f that may point in the +Z-direction of FIG. 8. As shown in FIG. 9, foot 235f may releasably couple to a recess of housing 101 that may be similar to recess 101r₂. The coupling of foot 235f to this recess may, for example, be similar to the coupling of foot 234f to recess 101r2 (e.g., as described above with respect to FIGS. 5 and 6).

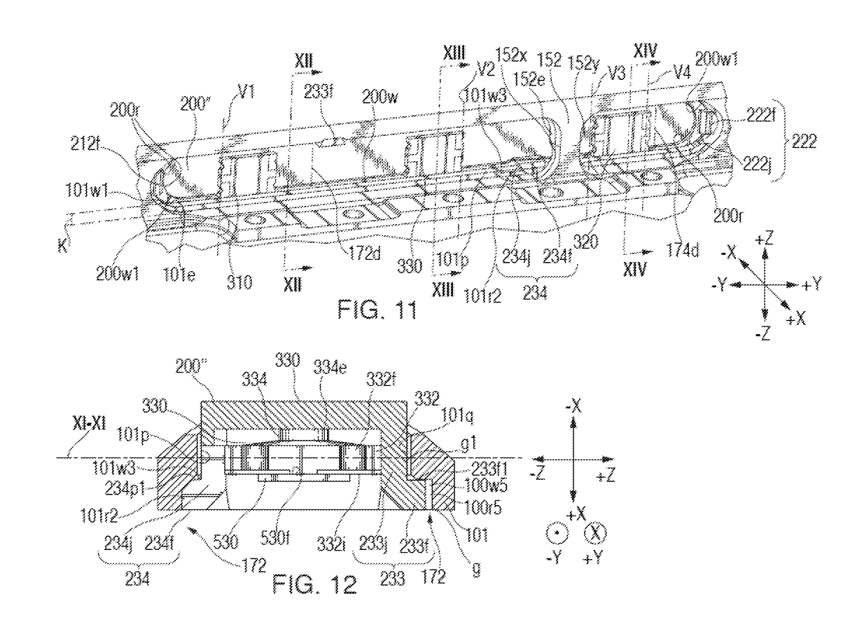

As shown in FIG. 9, for example, limb 235 may be positioned directly across from limb 234. It should be appreciated that, although limb 235 may be shown as being positioned directly across from limb 234, limb 235 may, instead, be shifted in any of the ±Y-directions of FIG. 8, by any suitable amount. As shown in FIGS. 10 and 11, for example, a button assembly 200″ may be the same as button assembly 200, but may include another alternative limb configuration (e.g., that may be different than the alternative limb configuration of button assembly 200′). As with button assembly 200′, button assembly 200″ may also include center region 230, end regions 210 and 220, and all the features thereof that have been described above with respect to FIGS. 2A-7. Button assembly 200″ may also include limbs 212 and 222. Moreover, button assembly 200″ may also include limb 234 adjacent side surface 230s. However, rather than including limb 232 adjacent side surface 230s (e.g., as with button assembly 200) or limb 235 adjacent side surface 230p positioned directly across from limb 234 (e.g., as with button assembly 200′), button assembly 200″ may include a limb 233 adjacent side surface 230p that may be shifted in the −Y-direction of FIG. 10 from limb 234, by a predetermined amount. Limb 233 may include a leg 233j that may be similar to leg 234j, and that may protrude from button assembly 200 in the +X-direction. Limb 235 may also include a foot 233f that may point in the +Z-direction. Foot 233f may releasably couple or otherwise interact with a recess of housing 101 that may be similar to recess 101r2. The interaction of foot 233f with this recess may, for example, be similar to the interaction of foot 234f with recess 101r2 (e.g., as described above with respect to FIGS. 5 and 6).

As shown in FIG. 12, for example, leg 233j of button assembly 200″ may rest on or run adjacent to a portion of surface 101q of housing 101, and foot 233f may releasably couple or otherwise interact with a recess 101r₅ of housing 101. In particular, a front surface 233f1 of foot 233f may hook, latch, contact, or otherwise interact with a wall portion 101w5 of recess 101r5, which may prevent movement of button assembly 200″ in the −X-direction. Similarly, leg 234j of limb 234 may rest on or run adjacent to a portion of surface 101p of housing 101, and foot 234f may releasably couple or otherwise interact with recess 101r2. In particular, a front surface 234f1 of foot 234f may hook or latch onto wall portion 101w3 of recess 101r2, which may further prevent movement of button assembly 200″ in the −X-direction.

As shown in FIG. 12, for example, switch 330 may be coupled to a circuit board 530″. Circuit board 530″ may be a central or primary printed circuit board (“PCB”) of electronic device 100, and may also be known as a main circuit board, motherboard, mainboard, baseboard, system board, planar board, or logic board. In some embodiments, circuit board 530″ may be a flexible circuit board or a set of flexible traces that may, for example, be coupled to another circuit board (not shown) of electronic device 100. In these embodiments, one or more portions of circuit board 530″ may bendable in one or more directions. Circuit board 530″ may provide one or more attachment points to switch 330. Generally, most of the basic circuitry and components required for electronic device 100 to function may be onboard or coupled (e.g., via one or more cables, bond pads, leads, terminals, cables, wires, contact regions, etc.) to circuit board 530″. For example, surface 332i of switch 330 may be mounted or otherwise coupled to a front surface 530″f of circuit board 530″. Circuit board 530″ may include one or more chipsets or specialized groups of integrated circuits. For example, circuit board 530″ may include two components or chips, such as a Northbridge and Southbridge. Although in other embodiments, these chips may be combined into a single component. Besides switch 330, various other electronic components (e.g., a processor, memory, power supply, communications circuitry, input component, output component, and combinations thereof) may also be mounted or otherwise coupled to suitable portions of circuit board 530″.

Although FIG. 12 may only show a portion of circuit board 530″, it should be appreciated that circuit board 530″ may extend in any one of the ±Y-directions, similar to how button assembly 200″ may extend in the ±Y-directions (e.g., as shown in FIGS. 10 and 11). In some embodiments, circuit board 530″ may extend at least from a line V1 to a line V4 of FIG. 11. For example, circuit board 530″ may be coupled to each of switches 310, 320, and 330, where a portion of circuit board 530″ may be positioned between external surface 152e of structural post 152 and a portion of button assembly 200″. In such embodiments, circuit board 530″ may be thin enough (e.g., equal to or less than distance k) such that it may fit between external surface 152e of structural post 152 and the adjacent portion of button assembly 200″. In other embodiments, separate circuit boards 530″ may be employed. For example, a first circuit board 530″ may be coupled to switches 310 and 320, and a second circuit board 530″, that may be at least partially separate from the first circuit board 530″, may be coupled to switch 320. In such embodiments, the first circuit board 530″ may extend at least from line V1 to a line V2 of FIG. 11, and the second circuit board 530″ may extend at least from a line V3 to a line V4 of FIG. 11.

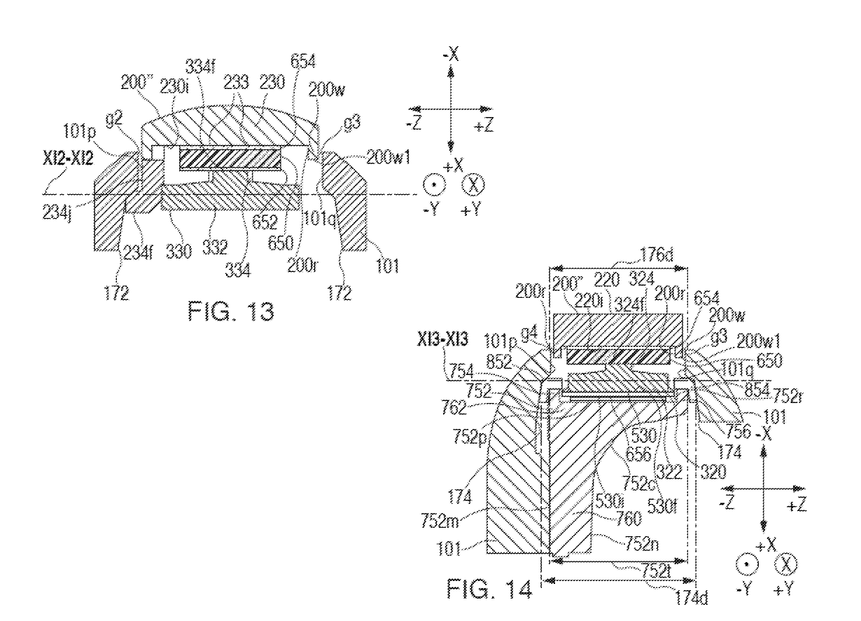

Although legs 212j, 222j, 232j, 233j, 234j, and 235j of limbs 212, 222, 232, 233, 234, and 235, respectively, have been described above as each resting against or being adjacent to a corresponding portion of housing 101 (e.g., surface 101p or 101q), in some embodiments, one or more gaps may exist between any of legs 212j, 222j, 232j, 233j, 234j, and 235j and the corresponding portion of housing 101. As shown in FIG. 12, for example, a gap g1 may exist between limb 233j and surface 101q. With such a gap g1, in addition to limb 233 being able to move in the +X-direction with respect to wall portion 101w5, limb 233 may also be able to move in the +Z-direction (e.g., towards surface 101q). As shown in FIG. 13, for example, a gap g2 may exist between limb 234 and surface 101p. Moreover, a gap g3 may exist between wall 200w and surface 101q. Each one of these gaps may, for example, prevent the legs of button assembly 200″ from brushing against corresponding surfaces 101p and 101q of housing 101. For example, over time, such brushing may wear out or damage button assembly 200″ and/or housing 101.

In some embodiments, it may additionally or alternatively be desirable to limit movement of button assembly 200″ (e.g., in the +Z-direction), while retaining each of these gaps. In these embodiments, button assembly 200″ may not be configured to directly contact switches 310, 320, and 330. Instead, button assembly 200″ may be configured to contact switches 310, 320, and 330 via one or more shims. As shown in FIG. 13, for example, portion 233 of center region 230 along surface 230i may be coupled to a shim 650. Shim 650 may be composed of any suitable material or combination of materials. In some embodiments, for example, shim 650 may be composed of a layer of stainless steel that may be sandwiched between two layers of pressure-sensitive adhesive (“PSA”). Each one of these layers of PSA may, for example, be composed of a polyethylene terephthalate (e.g., “PET” or polyester) carrier component that may be sandwiched between two adhesive components. In other embodiments, shim 650 may, for example, be composed of any one of the combinations of PSA and stainless steel, PSA and PET, and PSA, PET, and PSA.

As described above with respect to FIGS. 3A and 3B, a button assembly may vary in physical flexibility from region to region due to differences in the thickness of each one of the regions. For example, button assembly 200″ may vary in physical flexibility from end region 210 to center region 230, and from center region 230 to end region 220. A user may, for example, detect the difference in flexibility between the regions when depressing each one of these regions. In some embodiments, shim 650 may be constructed of PSA and stainless steel, and may be included between button assembly 200″ and the corresponding switches 310, 320, and 330 (e.g., a respective one of shim 650 may be positioned between center region 230 and switch 330, end region 210 and switch 310, and end region 220 and switch 320). In these embodiments, although the stainless steel of shim 650 may affect a user-detected flexibility of each one of center region 230 and end regions 210 and 220, the PSA of shim 650 may be compliant enough not to affect these flexibilities. In other embodiments, shim 650 may be constructed of plastic and stainless steel. In these embodiments, each one of the plastic and the stainless steel may affect the user-detected flexibility of each one of center region 230 and end regions 210 and 220.

Shim 650 may be larger than each of portion 233 and activator switch 334 in any one of the ±Y and ±Z-directions. Moreover, shim 650 may be small enough to couple to only a portion of center region 230. A first side of shim 650 may couple to center region 230 via an adhesive 654. Adhesive 654 may be composed of any suitable material (e.g., pressure-sensitive adhesive (“PSA”)). A second side of shim 650 may couple to activator surface 334f via an adhesive 652 (e.g., that may be similar to adhesive 654). As described above with respect to FIG. 4A (and further described below with respect to FIG. 14), each one of switches 310, 320, and 330 may be secured within housing 101 via one or more support brackets. Thus, by adhering center region 230 to switch 330 via a shim (e.g., as shown in FIG. 13), button assembly 200″ may also at least partially be secured within housing 101. In this manner, gaps (e.g., gaps g1-g3) may be present between button assembly 200″ and housing 101, but button assembly 200″ may be at least partially restricted from movement in at least the ±Z-directions.

Although FIG. 13 may show shim 650 being disposed between center region 230 and switch 330, it should be appreciated, that a shim (e.g., that may be similar to shim 650), and adhesives (e.g., that may be similar to adhesives 652 and 654) may also be disposed between any of end region 210 and switch 310 and/or between end region 220 and switch 320.

As described above with respect to FIG. 4A, for example, each one of switches 310, 320, and 330 may be secured in their respective predefined locations within housing 101. In some embodiments, switches 310, 320, and 330 may be secured in position by one or more support brackets. As shown in FIG. 14, for example, a bracket 752 may be included to secure switch 320 in its respective predefined location within housing 101. Bracket 752 may be composed of any suitable material (e.g., plastic, metal, etc.). Although FIG. 14 may only show a portion of bracket 752, it should be appreciated that bracket 752 may extend (e.g., while retaining its shape) in the ±Y-directions, similar to how button assembly 200″ may extend in the ±Y-directions (e.g., as shown in FIGS. 10 and 11), and similar to how circuit board 530 may extend in ±Y-directions (e.g., as described above with respect to FIG. 12). Moreover, bracket 752 may also extend in the +X-direction. Bracket 752 may include an arm portion 760 and a hand portion 762. Arm portion 760 may lead into hand portion via a curve 752c. Surface 752m of arm portion 760 may rest upon and/or couple to (e.g., via an adhesive, a screw, etc.) a corresponding portion of housing 101. In this manner, bracket 752 may be at least partially fixed within housing 101. Hand portion 762 may include walls 754 and 756, and a recess 752r that may reside between walls 754 and 756. Recess 752r may be configured to support at least a portion of circuit board 530 via a recess surface 752p. As shown in FIG. 14, for example, an internal surface 530i of circuit board 530 may be coupled to recess surface 752p via an adhesive 656. Adhesive 656 may be similar to any one of adhesives 652 and 654. Front surface 530f of circuit board 530 may also be coupled to switch 320. In this manner, switch 320 may be secured in its respective location within housing 101 via bracket 752.

In some embodiments, bracket 752 may be configured to extend from at least line V1 to line V2 of FIG. 11 without interruption. However, due to the position of structural post 152, the shape of bracket 752 may not be retained throughout its entire extension. As shown in FIG. 14, for example, bracket 752 may include arm portion 760 and hand portion 762. Bracket 752 may retain the shape of hand portion 762 at least from line V1 to line V2 (e.g., in order to support each one of switches 310 and 330). However, at any point between line V2 and edge 152x of structural post 152, the shape of hand portion 762 (or of bracket 752, in general) may begin to change in order to accommodate structural post 152. For example, each one of walls 752 and 754, and surface 752p of hand portion 762 may begin to recede farther in the +X-direction towards arm portion 760. As another example, the entirety of hand portion 762 may be removed (e.g., gradually), leaving only arm portion 760. As yet another example, the entirety of hand portion 762 may be removed (e.g., gradually), and at least a portion of arm portion 760 may also be removed (e.g., gradually). This change in shape of hand portion 762 (or of bracket 752, in general) may continue in the +Y-direction, for example, until some point between edge 152y of structural post 152 and line V2. At this point, for example, bracket 752 may gradually retain its prior shape (e.g., hand portion 762 may retain its prior shape) such that bracket 752 may support switch 320 (e.g., similar to how bracket 752 may support each one of switches 310 and 330).

In other embodiments, rather than changing a shape of a single bracket 752 to accommodate structural post 152, separate first and second brackets 752 may be employed. For example, a first bracket 752 may be employed to secure switch 320, and a second bracket 752 may be employed to secure one or more of switches 310 and 330. For example, the first bracket 752 may extend at least from line V3 to line V4 of FIG. 11, and the second bracket 752 may extend at least from line V1 to line V2 of FIG. 11. Each surface 752m of the first bracket 752 and the second bracket 752 may be secured to a corresponding portion of housing 101. In this manner, each one of switches 310, 320, and 330 may be secured in their respective locations within housing 101. Moreover, in these embodiments, the first bracket 752 and the second bracket 752 may further couple or adjoin to each other at one or more points beyond structural post 152 (e.g., beyond the predefined distance k from external surface 101e of housing 101).

In some embodiments, although a thickness 752t of bracket 752 may be equal to or larger than a width 176d of opening 176, thickness 752t may be less than a width 174d of opening 174. Thus, even if at least one portion of surface 752m of bracket 752 may be secured to housing 101 (e.g., as described above), hand portion 762 of bracket 752 may still be able to move in at least the ±Z-directions with respect to housing 101. Thus, additionally or alternatively, electronic device 100 may include one or more gaskets 852 and 854 that may be configured to couple bracket 752 with housing 101. Gasket 852 may be similar to gasket 854, and may be composed of any suitable material (e.g., silicone, elastomer (e.g., urethane), etc.). As shown in FIG. 14, for example, gasket 852 may be configured to fit (e.g., snug fit) between a portion of wall 754 and a corresponding portion of surface 101p of housing 101. Similarly, gasket 854 may be configured to fit (e.g., snug fit) between a portion of wall 756 and a corresponding portion of surface 101q of housing 101. In this manner, hand portion 762 of bracket 752 may be at least partially restricted from movement in the ±Z-directions within housing 101.

Although FIG. 14 may only show a portion of each of gasket 852 and 854, it should be appreciated that each one of gasket 852 and 854 may extend in the ±Y-directions. For example, each one of gasket 852 and 854 may extend in the ±Y-directions at least as much as bracket 752 may extend in the ±Y-directions. In some embodiments (e.g., in the embodiments described above, where a first bracket 752 may be employed to secure switch 320, and a second bracket 752 may be employed to secure switches 310 and 330), corresponding first gaskets 852 and 854 and second gaskets 852 and 854 may be employed. Moreover, in some embodiments, gaskets 852 and 854 may not be separate components, but may instead be a single gasket unit. For example, the single gasket unit may line at least a portion of the perimeter of one or more of openings 172 and 174. Thus, in the embodiments described above (e.g., where a first bracket 752 may be employed to secure switch 320 and a second bracket 752 may be employed to secure switches 310 and 330), electronic device 100 may include a first single gasket unit that may line at least a portion of the perimeter of opening 172 to secure arm portion 762 of the first bracket 752 to housing 101. Similarly, electronic device 100 may also include a second single gasket unit that may line at least a portion of the perimeter of opening 174 to secure arm portion 762 of the second bracket 752 to housing 101.

As described above with respect to FIGS. 5 and 6, when button assembly 200 is integrated with electronic device 100, each one of limbs 212, 222, 232, and 234, and thus each one of feet 212f, 222f, 232f, and 234f, of button assembly 200 may be free to move at least a predetermined distance in the +X-direction (e.g., to allow movement of a corresponding one of regions 210, 220, and 230, when an external force is applied to that region in the +X-direction). As also described above with respect to FIGS. 5 and 6, housing 101 may include a respective space 101s that may be positioned directly adjacent a corresponding one of wall portions 101w1-101w4, such that each one of limbs 212, 222, 232, and 234 may be free to move away from a corresponding one of wall portions 101w1-101w4 and farther into electronic device 100. In some embodiments, each space 101s may be disposed between a respective one of limbs 212, 222, 232, and 234 and a corresponding portion of either one of gasket 852 and 854 or a corresponding portion of a single gasket unit, if a single gasket as described above is employed). In these embodiments, although each one of limbs 212, 222, 232, and 234 may be free to move away from a corresponding one of wall portions 101w1-101w4 and farther into electronic device 100 (e.g., when an external force is applied to a corresponding region of button assembly 200 in the +X-direction), a corresponding portion of gasket 650 may provide a rebound or spring force that may push a corresponding limb back towards a corresponding wall. That is, although button assembly 200 may be configured to automatically return to its natural state after an applied external force is removed (e.g., from any one of regions 210, 220, and 230), the gasket may further ensure that each region of button assembly 200 may return to its respective natural state.

As described above with respect to FIGS. 5 and 6, for example, housing 101 may include structural post 152 that may be positioned a predefined distance k from external surface 101e. Additionally or alternatively, housing 101 may include a structural post (e.g., that may be similar to structural post 152) at one or more other locations within housing 101. For example, in some embodiments, housing 101 may include a structural post that may extend from surface 101p (e.g., similar to how structural post 152 may extend from surface 101p), and that may be positioned any suitable distance from the position of structural post 152 in the ±Y-direction. Moreover, in some embodiments, housing 101 may not include any structural posts at all. In these embodiments, housing 101 may be constructed to be sufficiently stable, such that any structural post (e.g., structural 152) may not provide any further structural stability to housing 101 adjacent external opening 176.

Although FIG. 14 may show switch 320 disposed between shim 650 and circuit board 530, in some embodiments, circuit board 530 may instead be sandwiched between button assembly 200″ and shim 650. In these embodiments, for example, shim 650 may be coupled to hand portion 762 of bracket 752, and switch 320 may be oriented such that activator surface 324f may face the +X-direction. In this manner, when end region 220 is depressed in the +X-direction, internal surface 220i may depress circuit board 530, which may, in turn, depress activator surface 324f onto shim 650 to activate switch 320.

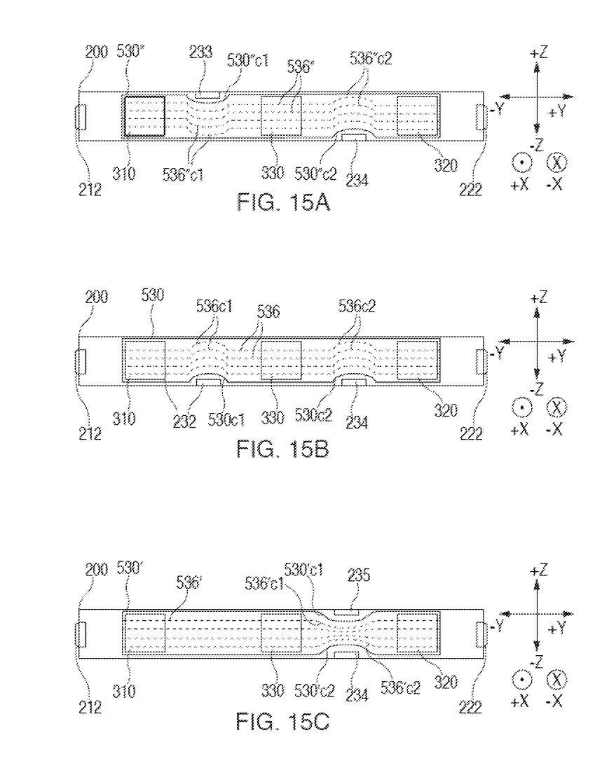

In some embodiments, button assembly 200″ may be integrated with electronic device 100. As shown in FIG. 15A, for example, circuit board 530″ may be coupled to each one of switches 310, 320, and 330 (e.g., via a set of electrical traces 536″), and may extend in the ±Y-directions. Because circuit board 530″ may be disposed adjacent to button assembly 200″ in the +X-direction, and because the protrusion of each one of limbs 233 and 234 in the +X-direction may at least partially interfere with the extension of circuit board 530″ in the ±Z directions, circuit board 530″ may, for example, be shaped to accommodate each one of limbs 233 and 234 to avoid such contact with limbs 233 and 234. As shown in FIG. 15A, for example, circuit board 530″ may include a curved portion 530″c1 and a curved portion 530″c2. Curved portion 530″c1 may curve towards the −Z-direction, and curved portion 530″c2 may curve towards the +Z-direction such that limbs 233 and 234, respectively, may be prevented from contacting and/or interfering with circuit board 530″. However, because curved portions 530″c1 and 530″c2 may result in at least a partial decrease in size of circuit board 530″ (e.g., in the Z-axis), the set of traces 536″ may also be arranged to accommodate this decrease in size. For example, each one of electrical traces 536″ may include a curved trace portion 536″c1, that may be curved similarly as curved portion 530″c1 (e.g., in the −Z-direction), to accommodate curved portion 530″c1. Moreover, each one of electrical traces 536″ may also include a curved trace portion 536″c2, that may be curved similarly as curved portion 530″c2 (e.g., in the +Z-direction), to accommodate curved portion 530″c2.

In some embodiments, button assembly 200 may be integrated with electronic device 100. As shown in FIG. 15B, for example, circuit board 530 may also be coupled to each one of switches 310, 320, and 330 (e.g., via a set of electrical traces 536), and may also extend in the ±Y-directions (e.g., similar to circuit board 530″ of FIG. 15A). Because circuit board 530 may be disposed adjacent to button assembly 200 in the +X-direction, and because the protrusion of each one of limbs 232 and 234 in the +X-direction may at least partially interfere with the extension of circuit board 530 in the ±Z directions, circuit board 530 may, for example, be shaped to accommodate each one of limbs 232 and 234 to avoid such contact with limbs 232 and 234. As shown in FIG. 15B, for example, circuit board 530 may include a curved portion 530c1 and a curved portion 530c2. Curved portions 530c1 and 530c2 may curve towards the +Z-direction (e.g., similar to curved portion 530″c2 of FIG. 15A) such that limbs 232 and 234, respectively, may be prevented from contacting and/or interfering with circuit board 530. However, because curved portions 530c1 and 530c2 may result in at least a partial decrease in size of circuit board 530 (e.g., in the Z-axis), the set of traces 536 may also be arranged to accommodate this decrease in size (e.g., similar to the set of traces 536″ of FIG. 15A). For example, each one of electrical traces 536 may include a curved trace portion 536c1, that may be curved similarly as curved portion 530c1 (e.g., in the +Z-direction), to accommodate curved portion 530c1. Moreover, each one of electrical traces 536 may also include a curved trace portion 536c2, that may be curved similarly as curved portion 530c2 (e.g., in the +Z-direction), to accommodate curved portion 530c2.

In some embodiments, button assembly 200′ may be integrated with electronic device 100. As shown in FIG. 15C, for example, circuit board 530′ may also be coupled to each one of switches 310, 320, and 330 (e.g., via a set of electrical traces 536′), and may also extend in the ±Y-directions (e.g., similar to circuit board 530″ of FIG. 15A and circuit board 530 of FIG. 15B). Because circuit board 530′ may be disposed adjacent to button assembly 200′ in the +X-direction, and because the protrusion of each one of limbs 234 and 235 in the ^{±}Z-directions may at least partially interfere with the extension of circuit board 530′ in the ±Z directions, circuit board 530′ may, for example, be shaped to accommodate each one of limbs 234 and 235 to avoid such contact with limbs 234 and 235. As shown in FIG. 15C, for example, circuit board 530′ may include a curved portion 530′c1 and a curved portion 530′c2. Curved portions 530′c1 and 530′c2 may curve towards the −Z-direction and +Z-direction, respectively, such that limbs 234 and 235 may be prevented from contacting and/or interfering with circuit board 530′. However, because curved portions 530′c1 and 530′c2 may result in at least a partial decrease in size of circuit board 530 (e.g., in the Z-axis), the set of traces 536′ may also be arranged to accommodate this decrease in size (e.g., similar to the set of traces 536″ of FIG. 15A and the set of traces 536 of FIG. 15B). For example, electrical traces 536′ may include at least one curved trace portion 536′c1, that may be curved similarly as curved portion 530′c1 (e.g., in the −Z-direction), to accommodate curved portion 530′c1. Moreover, electrical traces 536′ may also include at least one curved trace portion 536′c2, that may be curved similarly as curved portion 530′c2 (e.g., in the +Z-direction), to accommodate curved portion 530′c2.

It should be appreciated that the size and shape of each button assembly, center region, end region, limb, bracket, and gasket may vary based on different factors, such as the size and shape of the housing of electronic device 100, the size and shape of various electronic components within electronic device 100, and the like.

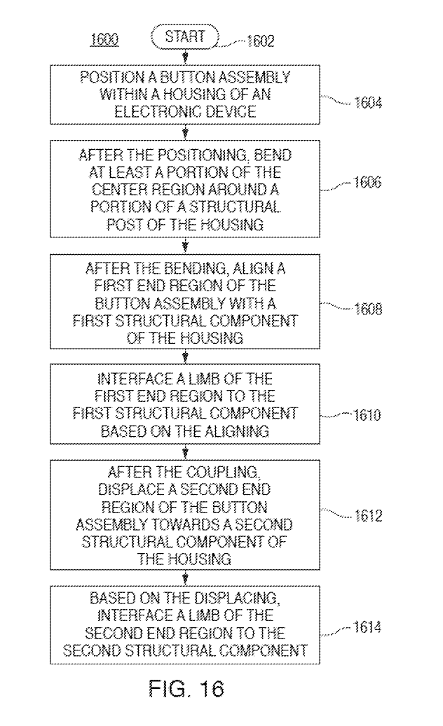

FIG. 16 is a flowchart of an illustrative process 1600 for integrating a button assembly (e.g., button assembly 200) with an electronic device (e.g., electronic device 100).

Process 1600 may begin at step 1602. At step 1604, process 1600 may include positioning a button assembly within a housing of an electronic device. For example, button assembly 200 may be positioned within housing 101 of electronic device 100 (e.g., while the portion of housing 101 shown in FIGS. 5 and 6 is made accessible). In particular, the button assembly may be oriented such that a front surface of the button assembly may face a direction that points away from the housing (e.g., out through external opening 176). For example, button assembly 200 may be positioned within housing 101 such that each one of surfaces 210f, 220f, and 230f may face the −X-direction out through external opening 176.

After the positioning, at step 1606, process 1600 may include bending at least a portion of the center region around a portion of a structural post of the housing. For example, a portion of center region 230 may be bent around structural post 152. In particular, the flexible configuration of center region 230 may allow button assembly 200 to bend.

After the bending, at step 1608, process 1600 may include aligning a first end region of the button assembly with a first structural component of the housing. For example, end region 220 of button assembly 200 may be aligned with a portion of housing 101 that may include wall portion 101w4.

At step 1610, process 1600 may include interfacing a limb of the first end region to the first structural component based on the aligning. For example, foot 222f of limb 222 may be interfaced with wall portion 101w4.

After the coupling, at step 1612, process 1600 may include displacing a second end region of the button assembly towards a second structural component of the housing. For example, end region 210 of button assembly 200 may be displaced towards wall portion 101w1 of housing 101.

Based on the displacing, at step 1614, process 1600 may include interfacing a limb of the second end region to the second structural component. For example, foot 212f of limb 212 may be interfaced with wall portion 101w1.

It is to be understood that the steps shown in FIG. 16 are merely illustrative and that existing steps may be modified, added, or omitted.

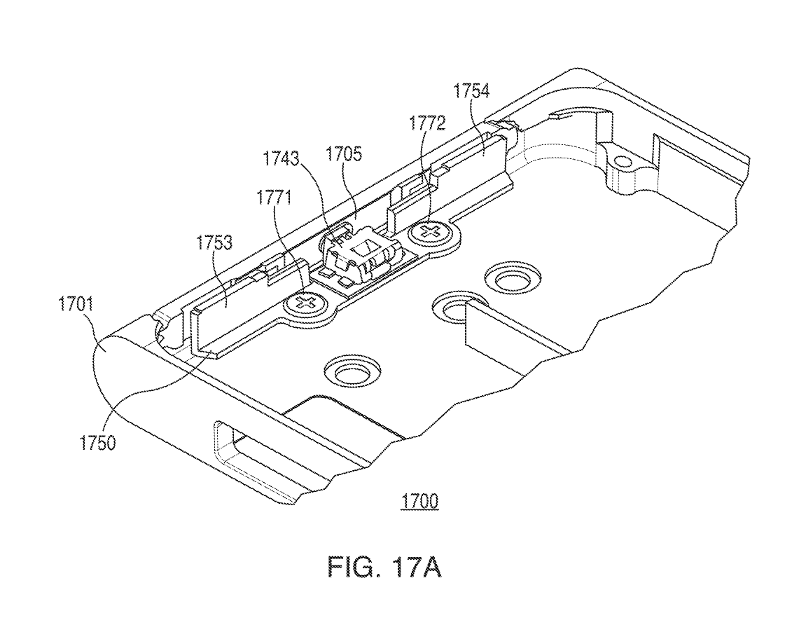

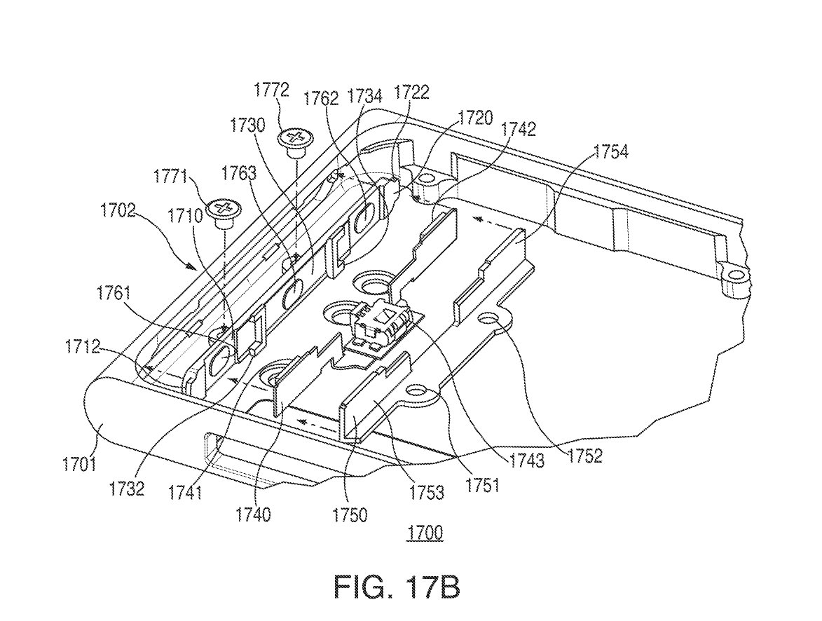

FIGS. 17A and 17B show various views of an illustrative electronic device 1700. More particularly, FIG. 17A shows a perspective view of a portion of electronic device 1700 including a button assembly, and FIG. 17B shows a similar view of electronic device 1700, but with the button assembly exploded. Electronic device 1700 can be similar to electronic device 100 of FIGS. 1-2B. Accordingly, electronic device 1700 can share any of the features described with respect to electronic device 100, and vice versa. Electronic device 1700 can include a housing 1701, a button 1705, a flexible printed circuit board (PCB) 1740, switches 1741-1743, and a bracket 1750.

Housing 1701 can include an aperture 1702 for accommodating button 1705. Housing 1701 can be made from any suitable material. For example, housing 1701 can be made from glass, plastic, metal, or any combination thereof. Button 1705 can be positioned within aperture 1702 and can form an external surface of electronic device 1700. Button 1705 can extend through aperture 1702 such that a portion of button 1705 is accessible to a user of the device. The user may apply a force to different regions of button 1705 (as discussed in more detail below) to provide inputs to electronic device 1700.

Button 1705 can include a center region 1730 and two end regions 1710 and 1720. In some embodiments, each one of regions 1710, 1720, and 1730 can exist as separate components that can be coupled to form button 1705. In these embodiments, for example, regions 1710, 1720, and 1730 can be connected in a contiguous manner. That is, there may be no physical discontinuities from end region 1710 to center region 1730, and from center region 1730 to end region 1720. In other embodiments, button 1705 can be constructed as a single structure (e.g., from a single piece of material). In these embodiments, button 1705 may not be physically formed from separable regions (e.g., such as regions 1710, 1720, and 1730). Rather, certain portions of button 1705 can be distinguished from one another based on, for example, a difference in one or more of their respective physical characteristics.

In some embodiments, button 1705 can vary in physical characteristics from region to region. For example, end regions 1710 and 1720 can have a predefined thickness that is different from a thickness of center region 1730. Further, the thicknesses of regions 1710, 1720, and 1730 can be substantially constant in some embodiments and can vary in other embodiments. For example, in one embodiment, end regions 1710 and 1720 can be substantially flat, whereas center region 1730 can include a curved portion. The curved portion can, for example, allow a user to tactilely distinguish the regions from one another (e.g., when a user brushes one or more fingers over button 1705).

In some embodiments, button 1705 can also include a set of limbs or flanges that each secures to a corresponding portion of electronic device 1700. For example, button 1705 can include flange portions 1712 and 1722. Flange portions 1712 and 1722 can extend from a sidewall of button 1705 and can engage portions of housing 1701 to keep button 1705 from passing through and out of aperture 1702. In this manner, flange portions 1712 and 1722 can secure button 1705 to housing 1701.

Button 1705 can also include limbs 1732 and 1734. Limb 1732 can be positioned on button 1705 so as to distinguish region 1710 from region 1730, and limb 1734 can be similarly positioned so as to distinguish region 1720 from region 1730. For example, limbs 1732 and 1734 can each serve as guide posts, where, when button 1705 is secured in position within housing 1701, a portion of button 1705 disposed between limbs 1732 and 1734 can constitute center region 1730, and the remaining end portions of button 1705 can constitute end regions 1710 and 1720, respectively. In some embodiments, region 1710 can end at the position of limb 1732, and one side of region 1730 can begin at that position. Similarly, region 1720 can end at the position of limb 1734, and another side of region 1730 can begin at that position. In other embodiments, limb 1732 can be positioned at least partially or entirely at region 1710. Similarly, limb 1734 can be positioned at least partially or entirely at region 1720.

To further secure button 1705 to housing 1701, limbs 1732 and 1734 may interact with bracket 1750. For example, limbs 1732 and 1734 can engage a top surface of bracket 1750. When a user presses on one of regions 1710, 1720, and 1730, limbs 1732 and/or 1734 can allow button 1705 to move in a certain manner (e.g., where a certain region can flex or otherwise change shape and make contact with a corresponding switch).

Switches 1741-1743 can be positioned beneath regions 1710, 1720, and 1730, respectively. A user can activate each of switches 1741-1743 by pressing the corresponding region of button 1705. Shims 1761-1763 can be included between switches 1741-1743 and button 1705 to provide a better fit between the switches and the button. Switches 1741-1743 can each be any suitable type of switches. For example, switches 1741 and 1742 can be dome switches and switch 1743 can be a side-firing switch.

Switches 1741-1743 can be fixed to a flexible PCB 1740 in any suitable manner (e.g., via solder). Flexible PCB 1740 can relay switch events from switches 1741-1743 to other components of electronic device 1700. For example, switches 1741 and 1742 can provide volume control and switch 1743 can provide play/pause functions. When one of switches 1741-1743 is activated, flexible PCB 1740 can relay a corresponding electrical signal to a processor of electronic device 1700 such that the intended function can be effected.

Bracket 1750 can serve as a mounting surface for switches 1741-1743 and flexible PCB 1740. For example, bracket 1750 can keep the switches in their intended positions beneath button 1705 even when button 1705 is actuated (e.g., by a user). Bracket 1750 can include platforms 1753 and 1754 for supporting switches 1741 and 1742, respectively. Bracket 1750 can also be secured to a portion of housing 1701 in any suitable manner. For example, bracket 1750 can be fixed to housing 1701 using screws 1771 and 1772.

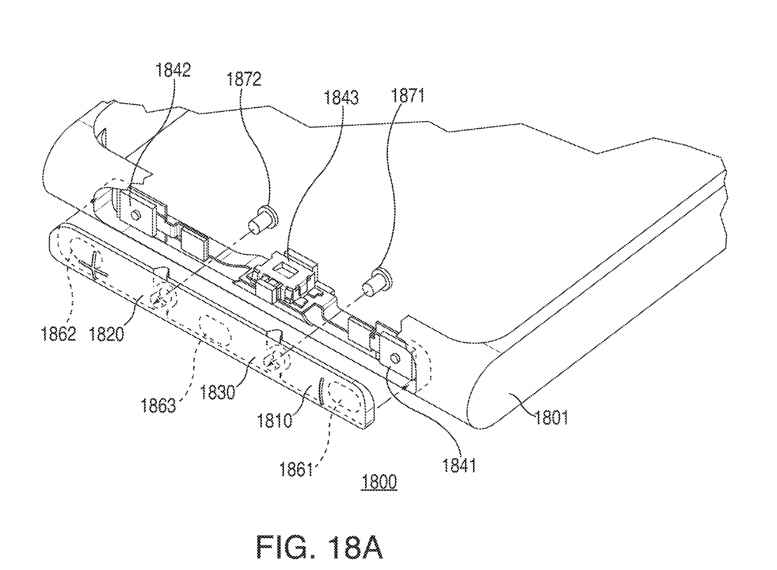

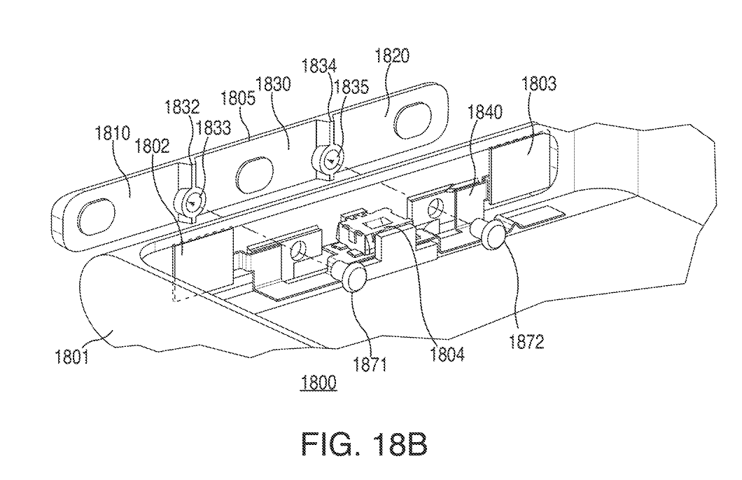

FIG. 18A shows a perspective view of an electronic device 1800, including an exploded view of another button assembly. FIG. 18B shows a view from the inside of electronic device 1800. Electronic device 1800 can be similar to electronic device 1700 of FIGS. 17A and 17B. Accordingly, electronic device 1800 can share any of the features described with respect to electronic device 1700, and vice versa. Electronic device 1800 can include a housing 1801, a button 1805, a flexible printed circuit board (PCB) 1840, and switches 1841-1843.

As shown in FIGS. 18A and 18B, electronic device 1800 may not include a bracket (e.g., a bracket like bracket 1750 of FIG. 17A). Rather, electronic device 1800 can include fasteners 1871 and 1872 that interface directly with button 1805 to secure button 1805 to housing 1801. Button 1805 can include limbs 1832 and 1834. Limbs 1832 and 1834 can include holes 1833 and 1835, respectively, for receiving fasteners 1871 and 1872. Additionally, housing 1801 can include platforms (e.g., platforms 1802-1804) for supporting switches 1841-1843 and flexible PCB 1840 of electronic device 1800.

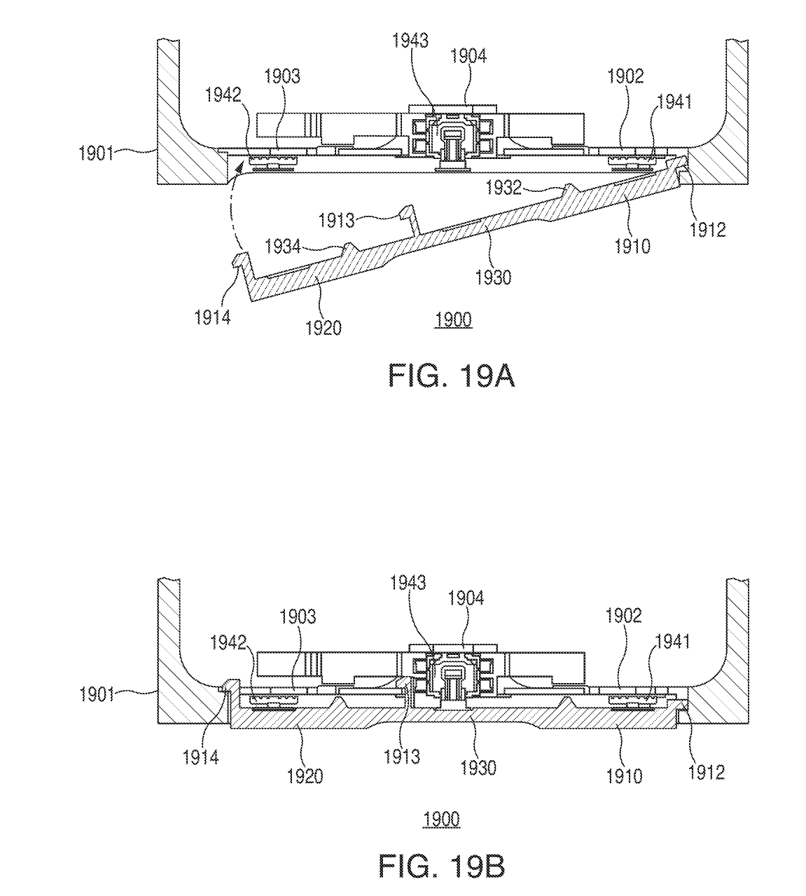

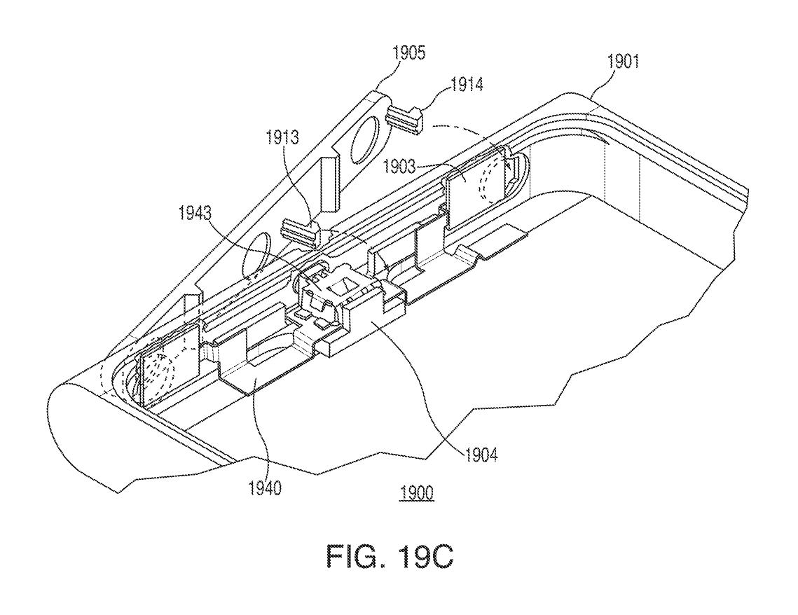

FIG. 19A shows a cross-sectional view of an electronic device 1900, including another button assembly. FIG. 19B shows a cross-sectional view of electronic device 1900, with the button assembly fully assembled. FIG. 19C shows a view from the inside of electronic device 1900. Electronic device 1900 can be similar to electronic device 1700 of FIGS. 17A and 17B. Accordingly, electronic device 1900 can share any of the features described with respect to electronic device 1700, and vice versa. In particular, electronic device 1900 can include a housing 1901, a button 1905, a flexible printed circuit board (PCB) 1940, and switches 1941-1943.

As shown in FIGS. 19A-19C, electronic device 1900 may not require a bracket (e.g., a bracket like bracket 1750 of FIG. 17A). Rather, button 1905 can include extensions 1913 and 1914 that can each secure to corresponding portions of housing 1901. Housing 1901 can include platforms 1902-1904 for supporting switches 1941-1943 and flexible PCB 1940 of electronic device 1900.

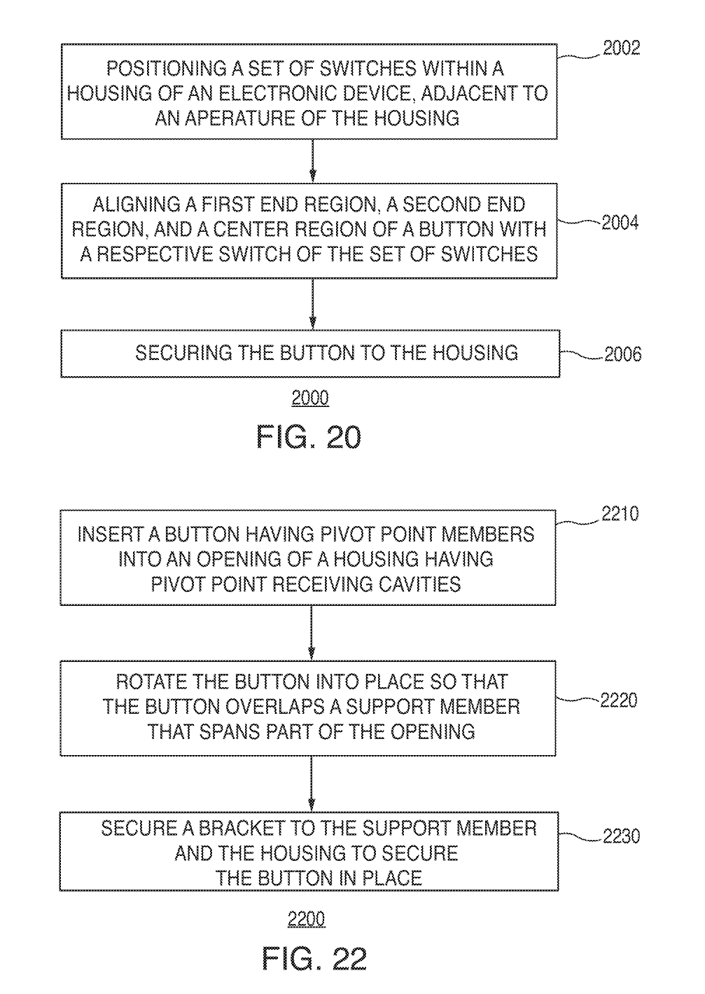

FIG. 20 shows an illustrative method 2000 for incorporating a button assembly in an electronic device. Method 2000 can begin at step 2002. At step 2002, the process can include positioning a set of switches within a housing of an electronic device, adjacent to an aperture of the housing. For illustrative purposes, the switches and electronic device can be similar to switches 1941-1943 and device 1900, respectively, of FIGS. 19A-19C. For example, the process can include positioning switches 1941 and 1943 within housing 1901 of electronic device 1900.

At step 2004, the process can include aligning a center region of a button (e.g., button 1905 of FIG. 19A) with a respective switch of the set of switches. For example, the process can include aligning a center region of button 1905 with a respective switch of switches 1941-1943.

At step 2006, the process can include securing the button to the housing. For example, the process can include securing button 1905 to housing 1901. The resulting configuration can, for example, look similar to the button assembly of FIG. 19B.

It is to be understood that the steps shown in FIG. 20 are merely illustrative and that existing steps may be modified, added, or omitted.

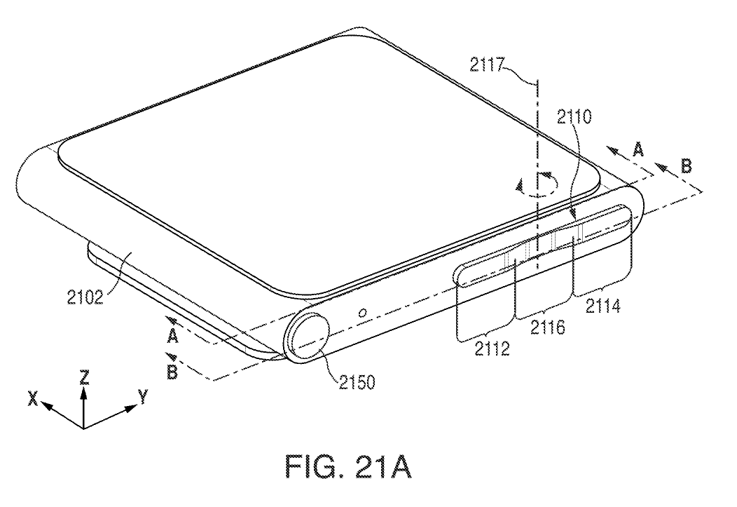

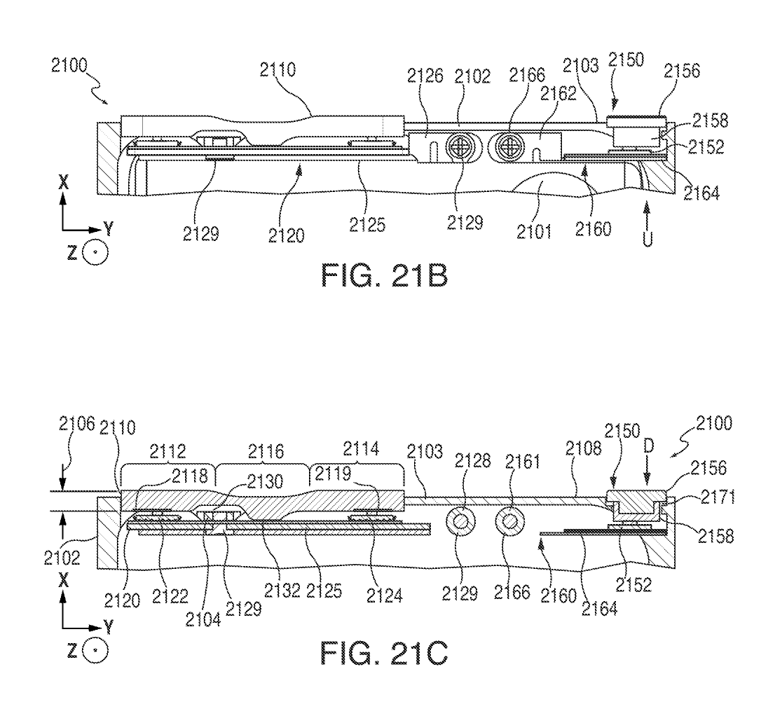

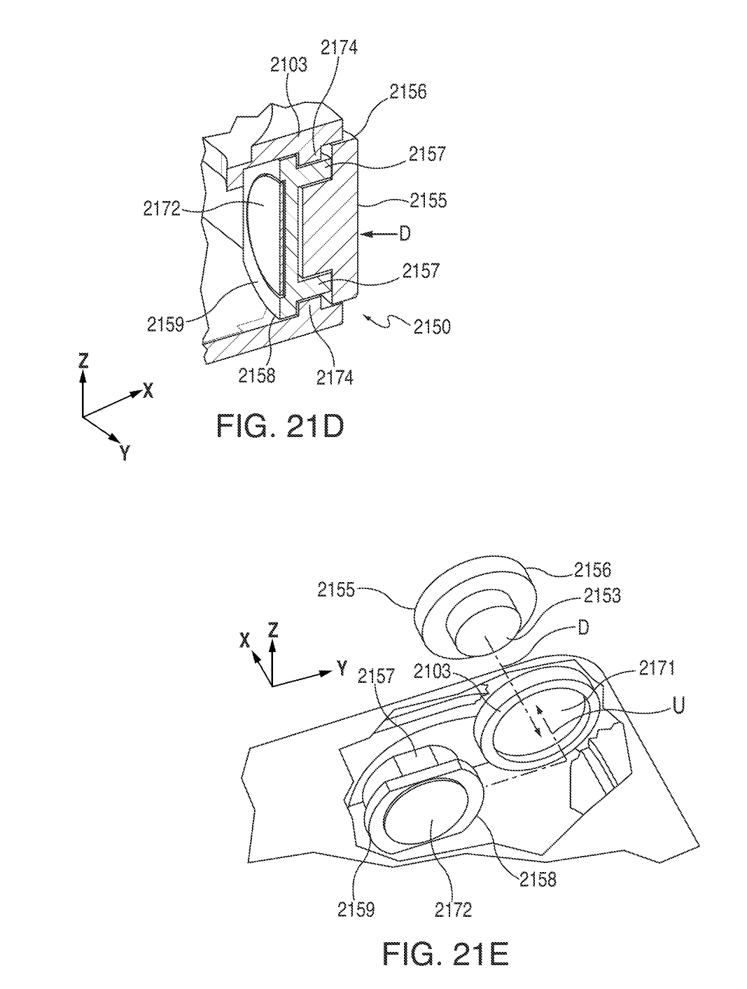

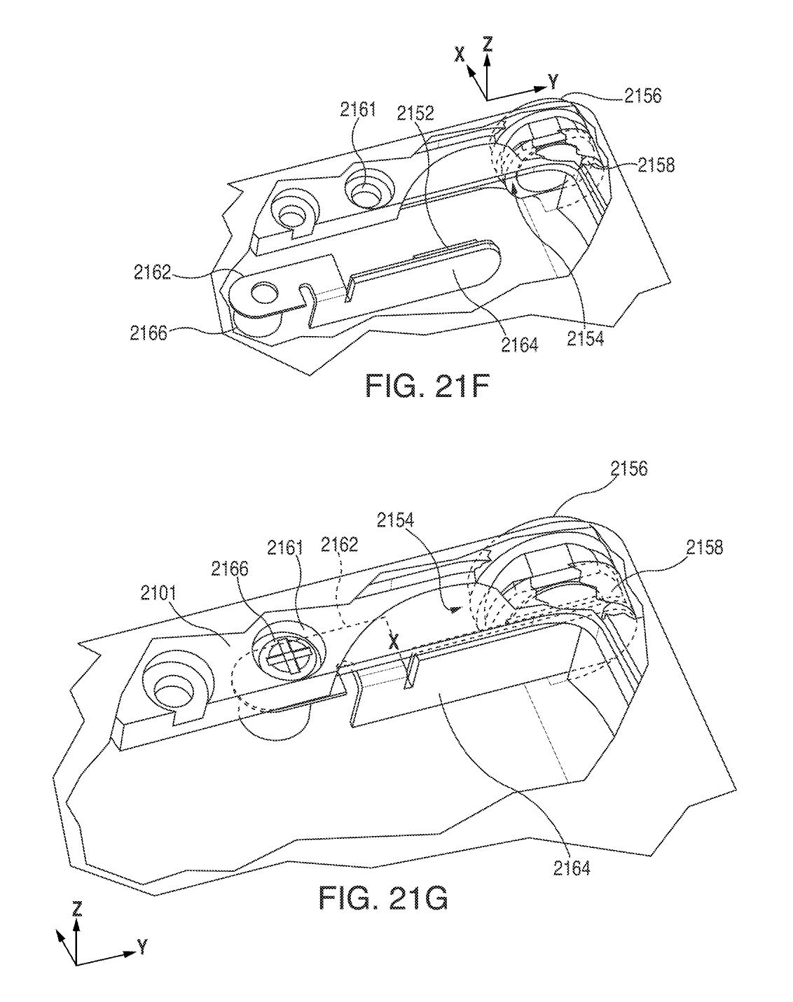

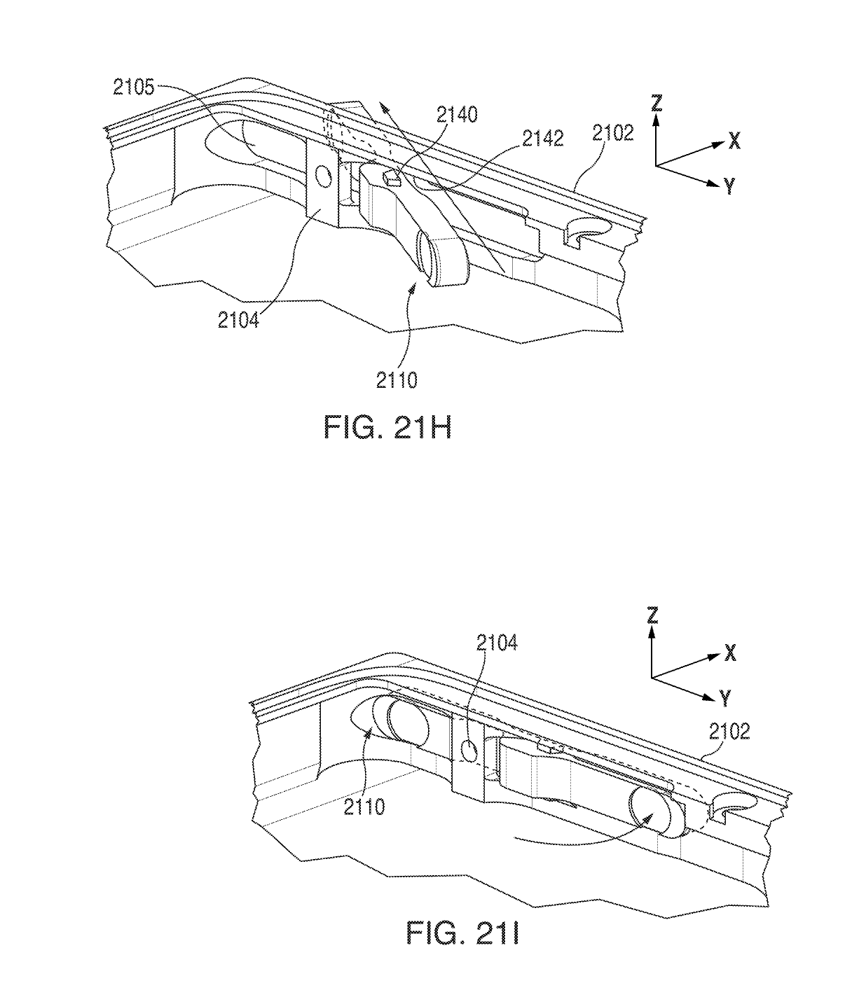

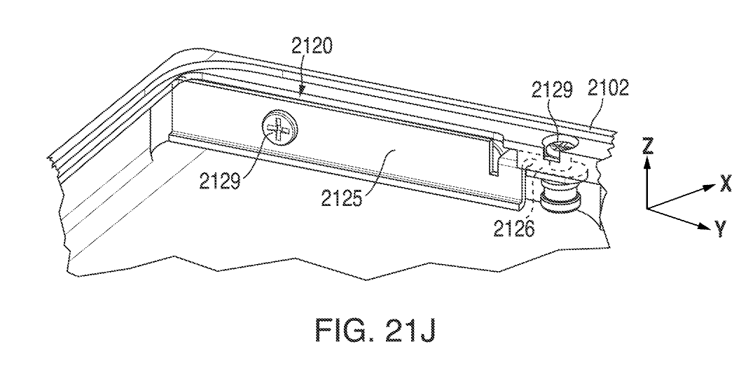

FIG. 21A shows an illustrative electronic device 2100 having a rocker button 2110 and an integrable button 2150. Both buttons 2110 and 2150 can include portions that extend beyond the periphery of a housing 2102. Rocker button 2110 can include regions 2112, 2114, and 2116. Regions 2112 and 2114 can form the end portions of button 2110 that a user can press onto to activate a switch (not shown). Button 2110 can, for example, be designated as a volume button. In this instance, region 2112 can correspond to a down volume switch and region 2114 can correspond to an up volume switch. Region 2116 can form a center region, or a pivot region, of button 2110. Button 2110 can rotate about a rotational axis 2117, which can be co-axially aligned with a center axis passing through region 2116. More particularly, button 2110 can rotate about the Z-axis such that regions 2112 and 2114 can move in the X-direction when depressed.

FIGS. 21B and 21C show illustrative cross-sectional views of device 2100 taken along line A-A of FIG. 21A. As shown in FIGS. 21B and 21C, for example, button 2110 can be positioned within an opening of housing 2102 and can span a support structure 2104. The opening and support structure 2104 are more clearly shown in FIG. 21H. Referring briefly to FIG. 21H, opening 2105 can be a relatively narrow opening existing on a narrow side of device 2100. Support structure 2104 can span a width of opening 2105 at a predetermined location. In some embodiments, support structure 2104 can be a part of housing 2102. In other embodiment, support structure 2104 can be a separate part fixed to housing 2102. Returning to FIGS. 21B and 21C, regardless of how structure 2104 is integrated with housing 2102, a portion of support structure 2104 can be located within housing 2102, and another portion can be offset from an outer surface of housing 2102 by a predefined distance 2106.

Pivot region 2116 can include pivot point members 2140 (one of which is shown in FIG. 21H). Pivot point members 2140 can reside on both sides of button 2110 and can be operative to engage pivot point receiver cavities 2142 (one of which is shown in FIG. 21H). Pivot point receiver cavities 2142 can be integrally formed within housing 2102. The combination of pivot point members 2140 and pivot point receiver cavities 2142 can serve as retaining and pivot mechanisms for button 2110.

Button 2110 can be secured in place via a bracket 2120. Bracket 2120 can be secured to support member 2104 and housing at a location 2128 via one or more fasteners 2129. Fasteners 2129 can include any suitable mechanism such as screws or pins. Bracket 2120 can include regions 2125 and 2126 disposed in different planes. More particularly, region 2125 can be disposed in the Y-Z plane and can be secured to support structure 2104 via a fastener 2129. Region 2126 can be disposed in the X-Y plane and can be secured to the housing at support structure 2104 by another fastener 2129. Regions 2125 and 2126 can be in substantially perpendicular planes. Thus, although region 2126 can be secured in the X-Y plane, bracket 2120 can still provide support for switches 2122 and 2124 and pivot region 2116 via region 2125. Although region 2125 can be further secured to housing 2102 via support member 2104, it is to be understood that the fastening of region 2126 to housing 2102 (e.g., alone without support member 2104) can also be sufficient for supporting button 2110. As described below, a bracket 2160, which can be secured by a single fastener, can also be employed support button 2150.

When bracket 2120 is secured to housing 2102, a portion of pivot region 2116 can interface with bracket 2120. More particularly, pivot region 2116 can interface with bracket 2120 at a location 2132 such that button 2110 can pivot in the event of switch activation events. When bracket 2120 is mounted to housing 2102, a gap or cavity can also exist at a location 2130, which can prevent button 2110 from interfering or interacting with support member 2104 during switch activation events.

Switches 2122 and 2124 can be mounted on predetermined portions of bracket 2120 such that, when bracket 2120 is mounted to housing 2102, switch 2122 is disposed beneath region 2112 and switch 2124 is disposed beneath region 2114. Button 2110 can also include shims 2118 and 2119 that can interface with switches 2120 and 2124, respectively. Switches 2122 and 2124 can be disposed on a circuit board (not shown) or a flexible printed circuit board (not shown).

Button 2150, which can be disposed adjacent to button 2110, can also be employed to provide inputs to electronic device 2100. Button 2150 can include a cap 2156 and a base 2158, and can be positioned adjacent a switch 2152, a shim (not shown), and other components such as a circuit board (also not shown). Button 2150 can be retained within housing 2102 using any one of a number of approaches, several of which are discussed below in connection with FIGS. 21D to 21G. Regardless of how button 2150 is retained, a predetermined amount of X-direction play can be provided to allow button 2150 to be depressed to engage switch 2152. Switch 2152 can also bias button 2150 upwards such that, when a user presses down on button 2150, a tight tactile feel can be provided to the user.

Switch 2152 can be supported by bracket 2160. Bracket 2160 can include regions 2162 and 2164, which can be disposed on substantially perpendicular planes. More particularly, region 2162 can be disposed on the X-Y plane and region 2164 can be disposed on the Y-Z plane. Bracket 2160, and in particular, region 2162, can be secured to housing 2102 by a fastener 2166, while region 2164 can support switch 2152, button 2150, a shim (not shown), and other components such as a circuit board (also not shown). In this manner, although bracket 2160 can be secured to housing 2102 by a fastener in the X-Y plane, bracket 2160 can support button 2150 in the Y-Z plane.

FIG. 21D shows an illustrative perspective view of a partial cross-section of integrable button 2150. FIGS. 21E-21G show various illustrative perspective views of integrable button 2150 being installed into housing 2102. As shown in FIGS. 21D-21G, and as briefly described above, button 2150 can interface with a button support or bracket 2160. Region 2162 of button support 2160 can function as a housing bracket portion, and region 2164 of button support 2160 can function as a switch bracket portion. As shown in FIG. 21G, for example, housing bracket portion 2162 can extend along a first portion 2101 of housing 2102 of device 2100 (e.g., in an X-Y plane along an interior portion of housing 2102 that also extends in an X-Y plane). Housing bracket portion 2162 can be coupled to that housing portion 2101 by a coupling feature 2166 (e.g., a screw coupling feature 2166 that can be inserted along the Z-axis into an opening, or other suitable coupling feature 2161 of housing portion 2101 for coupling housing bracket portion 2162 to portion 2101). Switch bracket portion 2164 of button support 2160 can extend in a Y-Z plane (e.g., substantially perpendicular to the extension of housing bracket portion 2162), and can support a switch 2152 underneath an opening 2171 through housing 2102. Housing opening 2171 can be provided through a portion 2103 of housing 2102, which can be perpendicular (e.g., in a Y-Z plane) to housing portion 2101.

Button 2150 can be positioned at least partially through housing opening 2171, such that when button 2150 is depressed (e.g., in the X-direction or in the direction of arrow D through housing opening 2171 towards switch 2152), button 2150 can activate switch 2152. Button 2150 can include a button cap 2156 and a button base 2158. Button cap 2156 can include an external portion 2155 and an internal portion 2153 extending away from external portion 2155. Button base 2158 can include an internal portion 2159 and an external portion 2157 extending away from internal portion 2159. Button cap 2156 can be inserted at least partially through opening 2171 in the direction of arrow D from the external surface of housing portion 2103, such that internal portion 2153 extends at least partially through opening 2171, and such that external portion 2155 remains external to device 2100 above opening 2171. Button base 2158 can be inserted at least partially through opening 2171, in the direction of arrow U, from the inside of housing portion 2103 out towards button cap 2156. When inserted in this manner, external portion 2157 can extend at least partially through opening 2171, and internal portion 2159 can remain internal to device 2100 under opening 2171. When button cap 2156 and button base 2158 are at least partially inserted in opposite directions through opening 2171, at least a portion of internal portion 2153 of cap 2156 can interface or interlock with at least a portion of external portion 2157 of base 2158 (e.g., between portions 2174 of housing 2102 that can define opening 2171, as shown in FIG. 21D). As shown in FIGS. 21D-21G, external portion 2155 of cap 2156 and internal portion 2159 of base 2158 can each be sized larger than opening 2171, such that when internal portion 2153 of cap 2156 and external portion 2157 of base 2158 interlocks within opening 2171, external portion 2155 of cap 2156 and internal portion 2159 of base 2158 can be held on opposite sides of opening 2171 (e.g., on opposite sides of housing portions 2174 of housing 2102 that can define opening 2171). In this manner, button 2150 can be retained in position with respect to opening 2171. When retained in such a position, an internal surface of internal portion 2159 of base 2158 can face switch 2152. In some embodiments, an intermediate component 2172 (e.g., a shim) can also be coupled to the internal surface of internal portion 2159, and can face and interact directly with switch 2152. For example, when no user force is applied to cap 2156 in the direction of arrow D, component 2172, along with switch 2152 and plate 2164, can bias button 2150 away from switch 2152 in the direction of arrow U.

In some embodiments, when cap 2156 and base 2158 interlock, button 2150 can form a loose fit about opening 2171, and can be displaceable with respect to opening 2171 in any one of the directions of arrows D or U. When a force is applied to the external surface of external portion 2155 in the direction of arrow D, switch 2152 can interact with (e.g., can apply an upward force on) the internal surface of internal portion 2159, in the direction of arrow U, to operate a circuit of device 2100. In some embodiments, internal portion 2153 of cap 2156 and external portion 2157 of base 2158 can interlock by a press-fit interaction. In other embodiments, internal portion 2153 to external portion 2157 can couple to one another via an adhesive or other coupling agent (not shown).

Referring now to FIGS. 21H-21J and FIG. 22, assembly of button 2110 within housing 2102 is described. Beginning at step 2210, the process can include inserting a button having pivot point members into an opening of a housing having pivot point receiving cavities. For example, as shown in FIG. 21H, button 2110 can have pivot point members 2140 insertable from the inside of housing 2102, which can have corresponding pivot point receiving cavities 2142. At step 2220, the process can include rotating the button in place so that the button overlaps a support member that spans part of the opening. As shown in FIG. 21I, for example, button 2110 can be rotated into place within opening 2105. Note that button 2110 can span support member 2104 when rotated into position.

At step 2230, the process can include securing a bracket to the support member and the housing to secure the button in place. As shown in FIG. 21J, for example, bracket 2120 can be secured to housing 2102. Region 2125 can be secured to support member 2104 with one fastener 2129, and region 2126 can be secured to housing with another fastener 2129.

It is to be understood that the steps shown in FIG. 22 are merely illustrative and that existing steps can be modified, added, or omitted. Moreover, although FIGS. 21A-21C can show an electronic device having two types of buttons, it should be appreciated that an electronic device can include one or more of these buttons, only one of these buttons, or one or more of these buttons in addition to one or more other types of buttons.

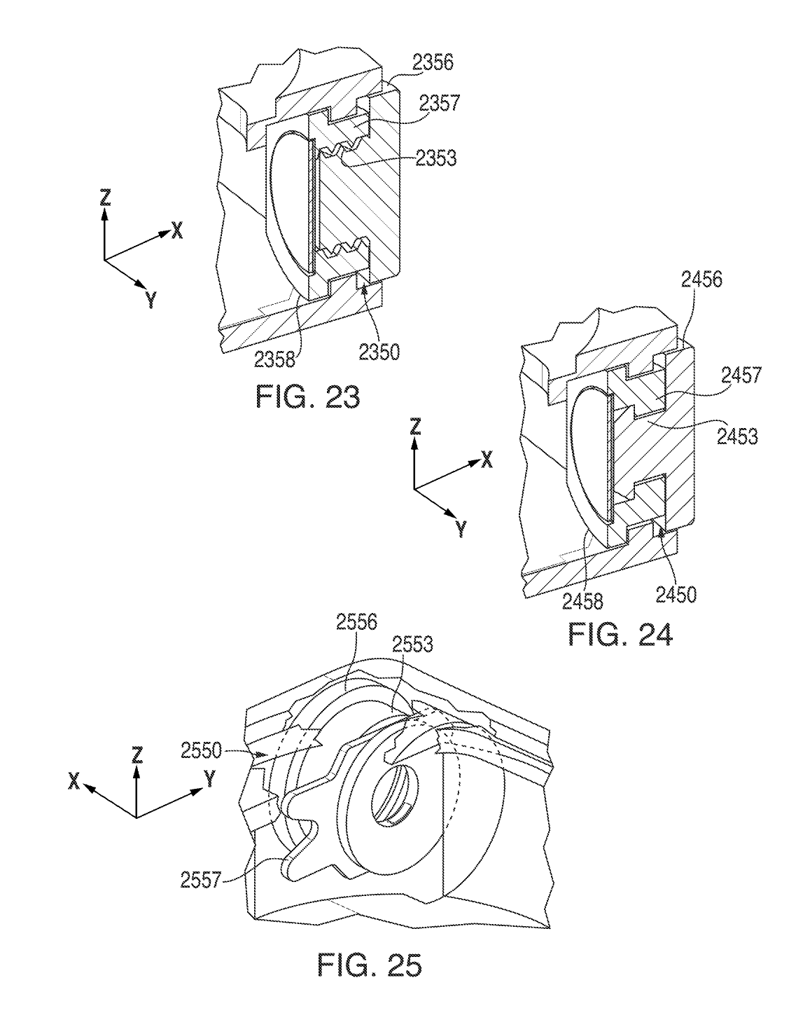

As described above with respect to FIGS. 21D-21G, a button can include a cap and base coupled to one another in a particular manner. However, in some embodiments, a button can be integrable or integrated in in other manners. FIG. 23 shows an illustrative perspective view of a partial cross-section of an alternate integrable button 2350 installed in a housing. As shown in FIG. 23, button 2350 can include a cap 2356 having an internal portion 2353 that interfaces or interlocks with an external portion 2357 of a base 2358 via a thread-and-screw interaction. For example, external portion 2357 can include threads configured to receive a screw head provided by external surfaces of internal portion 2353, such that cap 2356 can screw into base 2358 to integrate button 2350 to an opening of the housing.

FIG. 24 shows an illustrative perspective view of a partial cross-section of another alternate integrable button 2450 installed in a housing of an electronic device. As shown in FIG. 24, button 2454 can include a cap 2456 having an internal portion 2453 that can be deformable to fit through and stretch over rigid features of an external portion 2457 of a base 2458 of button 2454 so as to interlock internal portion 2453 with external portion 2457. For example, external portion 2457 can provide a hollow area through which a deformable portion (e.g., a rubber tip) of internal portion 2453 can squeeze through and then expand about. In this manner, cap 2456 can be retained in base 2458 to integrate button 2450 to an opening of the housing.

FIG. 25 shows an illustrative perspective view of yet another alternate integrable button 2550 installed in a housing. As shown in FIG. 25, button 2550 can include a cap 2556 having an internal portion 2353 that can fit through an opening in a housing portion (e.g., similar to housing portion 2102), but that can be held within the housing portion by a clip component 2557. Clip component 2557 can attach to internal portion 2553 and can be larger than the opening of the housing portion to prevent internal portion 2553 from escaping through that opening. Unlike external portions 2157, 2357, and 2457, clip 2557 may not be a part of a base 2558 of button 2550 that interacts with a corresponding switch (not shown in FIG. 25). Rather, an internal surface of internal portion 2553 can interact with the switch. For example, clip 2557 can wrap around an intermediate portion of internal portion 2553, such that an internal surface of internal portion 2553 (e.g., the surface of internal portion 2553 most internal to the device, which can be the same as or similar to device 2100) can be exposed to interact with the switch.

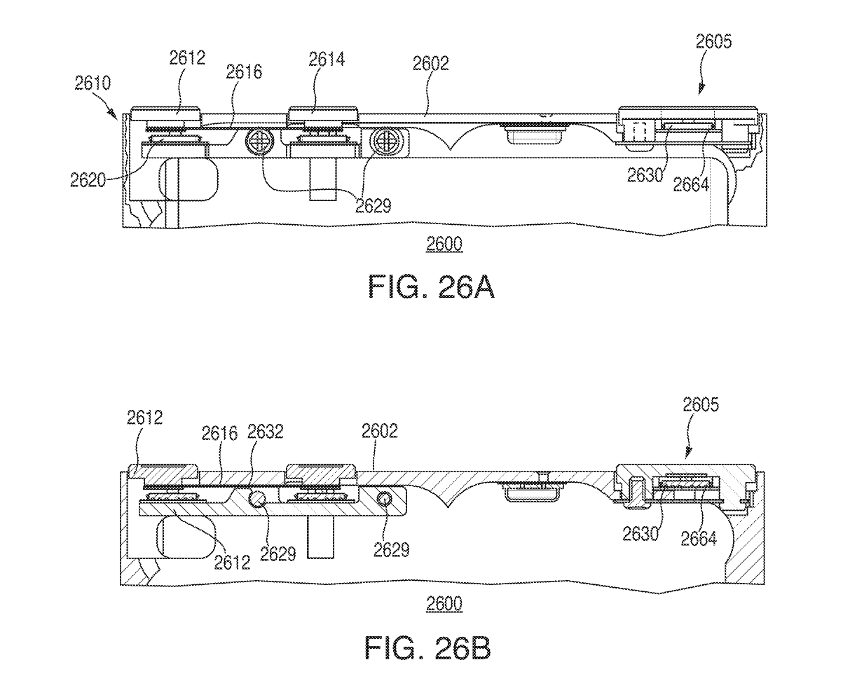

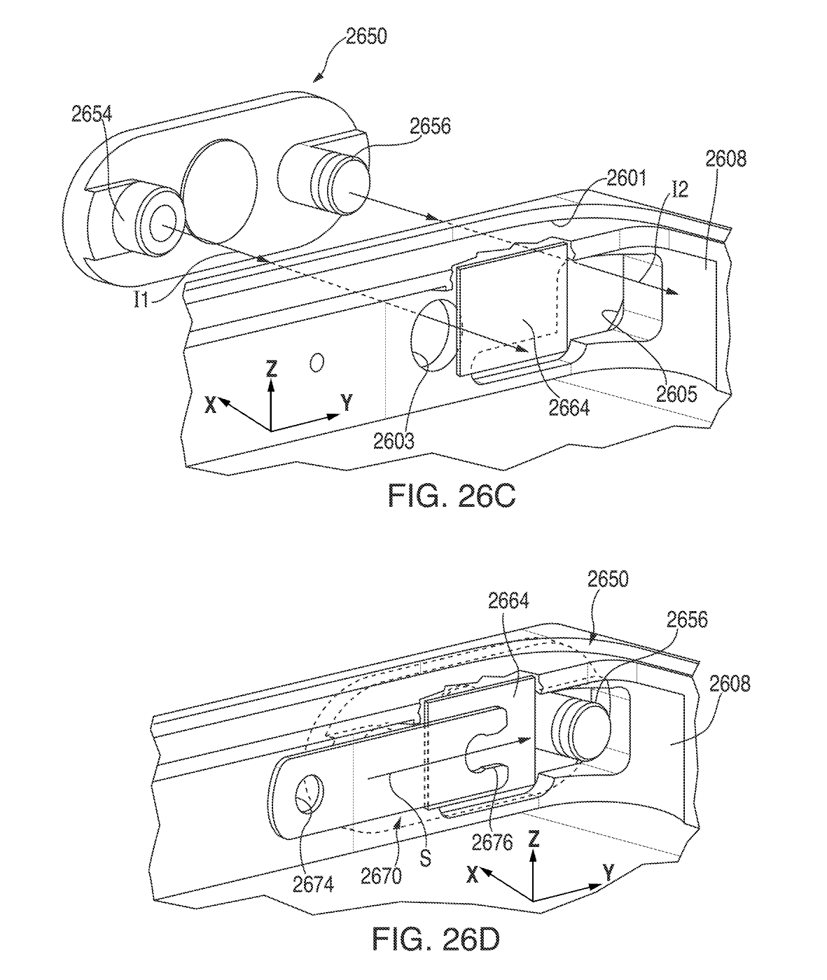

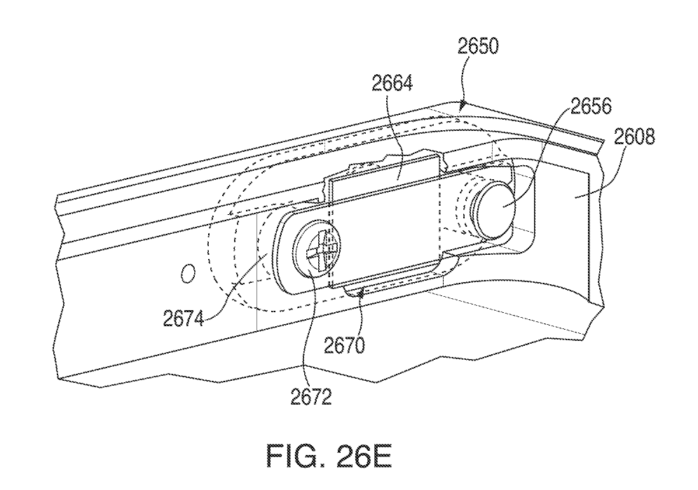

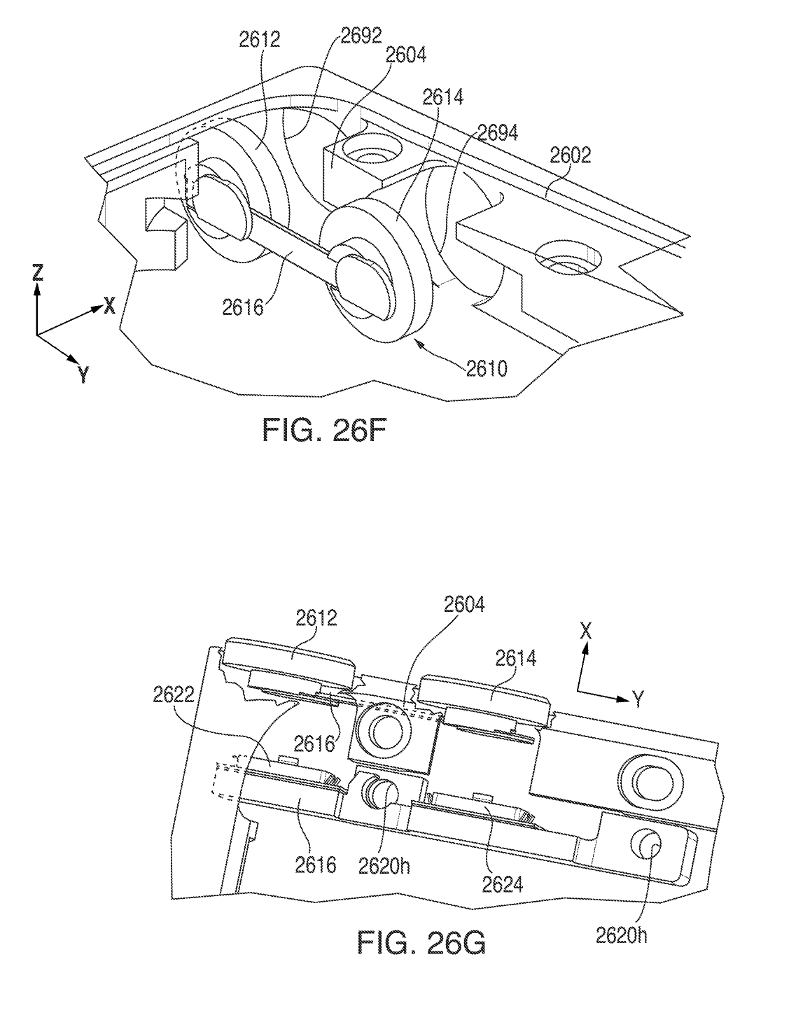

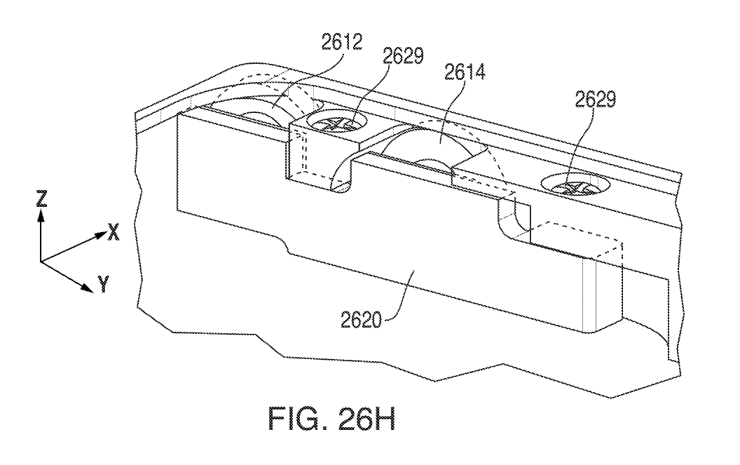

In some embodiments, an electronic device can include alternate button assembly configurations. FIGS. 26A and 26B show illustrative partial cross-sectional views of an electronic device 2600 having a spaced button assembly 2610. Electronic device 2600 can be similar to electronic device 2100, but can be configured to integrate with spaced button assembly 2610 that may not include a center region (e.g., such as center region 2216 of button 2110). As shown in FIGS. 26A and 26B, for example, spaced button assembly 2610 can include a support beam 2616 coupled to buttons 2612 and 2614 spaced from one another, and can be installed adjacent an inner portion of a housing 2602 of device 2610. Housing 2602 can include respective openings through which buttons 2612 and 2614 can reside or fit.

Similar to device 2100, device 2600 can include a bracket 2620 for securing spaced button assembly 2610 to housing 2602. Bracket 2620 can support switches 2622 and 2624, which can interface with buttons 2612 and 2614, respectively. Similar to bracket 2120 and housing 2102, bracket 2620 and housing 2602 can each include respective fastener receiving openings for receiving fasteners 2629 (e.g., screws), such that bracket 2620 and housing 2602 can sandwich, or otherwise secure, spaced button assembly 2610 in place. When bracket 2620 is secured to housing 2602, a portion of bracket 2620 can press support beam 2616 towards the inner portion of housing 2602. To allow buttons 2612 and 2614 to displace and provide inputs to device 2600, support beam 2616 can be retractably flexible. More particularly, the portion of bracket 2620 that presses flexible support beam 2616 onto the inner portion of housing 2602 can function as a pivot, and can allow each of buttons 2612 and 2614 to be respectively displaceable in the X-direction.

FIGS. 26C-26E show various illustrative perspective views of integrable button 2650 being installed into housing 2602 of electronic device 2600. As shown in FIGS. 26C-26E, button 2650 can be provided at least partially through an opening 2601 of housing 2602. Opening 2601 can be provided through an external surface of housing 2602, and can lead to at least two openings 2603 and 2605, each of which can be provided through an internal surface of housing 2602. Opening 2601 may not only lead to openings 2603 and 2605, but can also expose a mid-housing portion 2664 provided within and along a portion of opening 2601. As shown in FIG. 26B, a switch mechanism 2630 can also be supported by mid-housing portion 2664. Switch mechanism 2630 can include a TACT or tactile switch, or any other suitable type of switch that can be activated by button 2650. Button 2650 can be positioned at least partially within opening 2601 and over portion 2664 and switch 2630. Button 2650 can be configured to receive a force (e.g., from a user) at a top surface of button 2650 (e.g., in the directions of arrows I1 and I2) for depressing button 2650 towards switch 2630. This depression can compress switch 2630 between button 2650 and mid-housing portion 2664, which may activate a circuit of device 2600. Mid-housing portion 2664 may not only provide support for switch mechanism 2630, but also for a portion of housing 2602, which can be structurally weaker due to openings 2601, 2603, and 2605.

As shown in FIGS. 26C-26E, for example, button 2650 can include a first leg 2654 extending in the direction of arrow I1 into housing 2602 (e.g., through openings 2601 and 2603). Button 2650 can also include a second leg 2656 extending in the direction of arrow I2 into housing 2602 (e.g., through openings 2601 and 2605). Openings 2603 and 2605, as well as legs 2654 and 2656 can be positioned on opposite sides of mid-housing portion 2664 and switch mechanism 2630. A plate 2670 can be positioned adjacent the free ends of first leg 2654 and second leg 2656. As shown in FIG. 26E, for example, plate 2720 can be slid in the direction of arrow S, such that a first feature 2674 at a first end of plate 2670 can align with the free end of first leg 2654, and such that a second feature 2676 at a second end of plate 2670 can align with the free end of second leg 2656. First feature 2674 can allow the free end of first leg 2654 to couple to plate 2670, and second feature 2676 can allow the free end of second leg 2656 to couple to plate 2670. In this manner, mid-housing portion 2664 and switch mechanism 2630 can be retained between button 2650 and plate 2670. Plate 2670 can thus prevent legs 2654 and 2656 from departing openings 2603 and 2605, respectively, thereby retaining button assembly 2650 with respect to housing 2602 and switch mechanism 2630. In some embodiments, first feature 2674 can be a hole through which a screw can pass to attach to the free end of first leg 2654, which can include a threaded opening. Second feature 2676 can be a C-shaped opening that can fit around the free end of second leg 2616 (e.g., when plate 2670 is slid in the direction of arrow S). As shown in FIGS. 26D and 26E, second leg 2656 and opening 2605 can also be disposed close to a side wall 2608 of housing 2602, which can allow second feature 2676 to interact with second leg 2616, like first feature 2674 can interact with first leg 2614. As shown in FIG. 26D, for example, second feature 2676 can be configured to at least partially surround second leg 2616 within a groove of second leg 2656, and plate 2670 can be held at second feature 2676 by an enlarged free end portion of second leg 2656.

FIGS. 26F-26H show various illustrative perspective views of button 2610 being installed into housing 2602 of electronic device 2600. The installation of spaced button assembly 2610 can be the similar to the installation of rocker button 2110 into housing 2101 described above with respect to FIGS. 21H-21J. For example, button 2610 can be positioned adjacent such that support beam 2616 interfaces with a support portion 2604 of housing 2602, and such that buttons 2612 and 2614 can each be at least partially exposed through respective openings 2692 and 2694. As described above with respect to FIGS. 26A and 26B, bracket 2620 can support switches 2622 and 2624, and can also include holes 2620h that can each correspond to a respective hole of housing 2602. Via these holes, bracket 2620 can be coupled and secured to housing 2602 via fasteners 2629.

While there have been described systems and methods for providing inputs to an electronic device with a button assembly, it is to be understood that many changes may be made therein without departing from the spirit and scope of the invention. It is also to be understood that various directional and orientational terms such as “up” and “down,” “left” and “right,” “top” and “bottom,” “X”, “Y”, and “Z,” and the like are used herein only for convenience, and that no fixed or absolute directional or orientational limitations are intended by the use of these words. For example, the devices and/or assemblies of the invention can have any desired orientation. If reoriented, different directional or orientational terms may need to be used in their description, but that will not alter their fundamental nature as within the scope and spirit of the invention. Those skilled in the art will appreciate that the invention can be practiced by other than the described embodiments, which are presented for purposes of illustration rather than of limitation, and the invention is limited only by the claims which follow.

What is claimed is:

1. A button assembly comprising:
a button having a center region, a first end region extending from a first side of the center region, and a second end region extending from a second side of the center region that is opposite the first side;
a first limb coupled to the button proximate the first side of the center region;
a second limb coupled to the button proximate the second side of the center region; and
a plurality of switches positioned adjacent the button, at least one of the plurality of switches being actuatable when one of the center region, the first end region, and the second region is depressed.

2. The button assembly of claim 1, wherein the center region, the first end region, and the second end region form a single contiguous portion of the button assembly.

3. The button assembly of claim 1, wherein a flexibility of the button varies from the center region to at least one of the first end region and the second end region.

4. The button assembly of claim 1, wherein:
each one of the first and second end regions comprises a first thickness; and
the center region comprises a second thickness that is less than the first thickness.

5. The button assembly of claim 1, wherein the first limb is coupled to at least one of the center region and the first end region, and wherein the second limb is coupled to at least one of the center region and the first end region.

6. The button assembly of claim 1, wherein each of the first and second limbs comprises:
a surface having at least one hole for receiving a fastener.

7. The button assembly of claim 1, wherein the first and second limbs are disposed on the same side of the button.

8. The button assembly of claim 1, wherein each of the first end region and the second end region comprises:
a flange configured to secure to a corresponding portion of an electronic device.

9. An electronic device comprising:
a housing;
a plurality of switches disposed within the housing; and
a button secured to the housing and comprising a plurality of regions, each region of the plurality of regions being positioned adjacent to a respective switch of the plurality of switches, the button being configured to:
displace with respect to the housing in a first manner when an external force is applied to a first region of the plurality of regions; and
displace with respect to the housing in a second manner when the external force is applied to a second region of the plurality of regions.

10. The electronic device of claim 9, wherein the button comprises at least one hole for receiving a fastener, and wherein the button is secured to the housing via the fastener.

11. The electronic device of claim 9 further comprising a bracket secured to an inner surface of the housing, wherein the plurality of switches are mounted on the bracket.

12. The electronic device of claim 9, wherein the first region is disposed between the second region and a third region of the plurality of regions.

13. The electronic device of claim 12, wherein the button further comprises a first limb and a second limb, the first and second regions being distinguishable from one another by the first limb, and the first and third regions being distinguishable from one another by the second limb.

14. The electronic device of claim 13, wherein a thickness of the first region is less than a thickness of any one of the second and third regions.

15. The electronic device of claim 9, wherein each of the first and second regions comprises at least one limb configured to interact with a corresponding structural component of a portion of the housing.

16. A method of integrating a button assembly with an electronic device, the button assembly comprising a plurality of switches and a button having a first end region, a second end region, and a center region disposed between the first end region and the second end region, the electronic device comprising a housing having an aperture, the method comprising:
positioning the plurality of switches within the housing adjacent to the aperture;
aligning each of the first end region, the second end region, and the center region with a respective switch of the plurality of switches; and
securing the button to the housing.

17. The method of claim 16, wherein positioning comprises:
mounting each of the plurality of switches on a platform of the housing.

18. The method of claim 16, wherein positioning comprises:
mounting the plurality of switches on a bracket; and
fixing the bracket to the housing.

19. The method of claim 16, wherein securing comprises:
fastening the button to the housing at least one screw.

20. The method of claim 16, wherein the button comprises at least one limb configured to interact with a corresponding structural component of the housing, and wherein securing comprises:
engaging the at least one limb with the structural component.

21-32. (canceled)

33. A button assembly comprising:
a housing having an opening and a plurality of retention features positioned within the opening;
a button positioned within the opening, the button being partially retained by the plurality of retention features; and
a bracket having a first planar region and a second planar region, the first planar region interfacing with a first portion of the button assembly along a first plane, and the second planar region interfacing with a second portion of the button assembly along a second plane that is substantially perpendicular to the first region.
